(19) United States
(12) Patent Application Publication
(10) Pub. No.: US 2015/0006444 A1
(43) Pub. Date: Jan. 1, 2015

(54) METHOD AND SYSTEM FOR OBTAINING IMPROVED STRUCTURE OF A TARGET NEURAL NETWORK

(71) Applicant: DENSO CORPORATION, Kariya-city (JP)

(72) Inventors: Yukimasa TAMATSU, Okazaki-shi (JP); Ikuro SATO, Yokohama (JP)

(21) Appl. No.: 14/317,261

(22) Filed: Jun. 27, 2014

(30) Foreign Application Priority Data
Jun. 28, 2013 (JP) 2013-136241

(51) Int. Cl. G06N 3/08; G06N 99/00

(52) U.S. Cl. CPC G06N 3/08; G06N 99/005
USPC 706/12

(57) ABSTRACT

When it is determined that a minimum value of a cost function of a candidate structure obtained by a training process of a specified-number sequence is equal to or higher than that of the cost function of the candidate structure obtained by the first step of a previous sequence immediately before the specified-number sequence, a method performs, as a random removal step of the specified sequence, a step of randomly removing at least one unit from the candidate structure obtained by the first step of the previous sequence again. This gives a new generated structure of the target neural network based on the random removal to the first step as the input structure of the target neural network. The method performs the specified-number sequence again using the new generated structure of the target neural network.

### CROSS REFERENCE TO RELATED APPLICATIONS

This application is based on and claims the benefit of priority from Japanese Patent Application 2013-136241 filed on Jun. 28, 2013, the disclosure of which is incorporated in its entirety herein by reference.

### TECHNICAL FIELD

The present disclosure relates to methods and systems for obtaining improved structures of neural networks. The present disclosure also relates to program products for obtaining improved structures of neural networks.

### BACKGROUND

There are known methods for optimally establishing the structures of neural networks. An example of these methods is disclosed in X. Liang, “Removal of Hidden Neurons by Crosswise Propagation”, Neuron Information Processing-Letters and Reviews, Vol. 6, No 3, 2005, which will be referred to as a non-patent document 1.

The method, referred to as the first method, disclosed in the non-patent document 1 is designed to remove hidden-layer units, i.e. neurons, of a multi-layer neural network one by one, thus establishing an optimum network structure. Specifically, the first method disclosed in the non-patent document 1 requires an artificial initial network structure of a multi-layer neural network; the artificial initial network structure is designed to have a predetermined connection pattern among plural units in an input layer, plural units in respective plural hidden layers, and plural units in an output layer. After sufficiently training connection weights, i.e. connection weight parameters, between units of the different layers of the initial network structure, the first method removes units, i.e. neurons, in each of the hidden layers in the following procedure:

Specifically, the first method calculates correlations among outputs of different units in a target hidden layer with respect to training data, and removes, from a corresponding target hidden layer, one of units of one pair that have the highest correlation among the different units, thus creating an intermediate stage of the network structure.

After removal of one unit from a corresponding hidden layer, the first method restarts training of the connection weights between the remaining units of the different layers of the inter mediate stage of the network structure. That is, the first method repeatedly performs training of the connection weights between units of the different layers of a current inter mediate stage of the network structure, and removal of one unit in each of the hidden layers until a cost function reverses upward, thus optimizing the structure of the multilayer neural network.

An another example of these methods is disclosed in K. Suzuki, I. Horiba, and N. Sugie, “A Simple Neural Network Pruning Algorithm with Application to Filter Synthesis”, Neuron Processing Letters 13: 44-53, 2001, which will be referred to as a non-patent document 2.

The method, referred to as the second method, disclosed in the non-patent document 2 is designed to remove hidden-layer units or units in an input layer of a multi-layer neural network one by one, thus establishing an optimum network structure. Specifically, the second method disclosed in the non-patent document 2 requires an artificial initial network structure of a multi-layer neural network comprised of an input layer, plural hidden layers, and an output layer. After sufficiently training connection weights between units of the different layers of the initial network structure with respect to training data until a cost function becomes equal to or lower than a preset value, the second method removes units in each of the hidden and input layers in the following procedure:

Specifically, the second method calculates a value of the cost function with respect to training data assuming that a target unit in one hidden later or the input layer is selected to be removed. The second method repeats this calculation while changing selection of a target until all removable target units have been selected in the hidden layers and the input layers. Then, the second method extracts one of the selected target units whose calculated value of the cost function is the minimum in all the calculated target values of the other selected target units, thus removing the extracted target unit from a corresponding layer. This creates an intermediate stage of the network structure.

After removal of one unit from a corresponding layer, the second method restarts training of the connection weights between the remaining units of the different layers of the intermediate stage of the network structure. That is, the second method repeatedly performs training of the connection weights between units of the different layers of a current intermediate state of the network structure, and removal of one unit in each of the hidden and input layers until the cost function reverses upward, thus optimizing the structure of the multilayer neural network. As described above, the second method uses, as an evaluation index for removing a unit in a corresponding layer, minimization of the cost function of the current stage of the neural network.

A further example of these methods is disclosed in M. C. Mozer and P. Smolensky, “Skeletonization: A Technique for Trimming the Fat from a Network via Relevance Assessment”, Advances in Neural Information Processing Systems (NIPS), pp. 107-115, 1988, which will be referred to as a non-patent document 3.

The method, referred to as the third method, disclosed in the non-patent document 3 is designed to be substantially identical to the second method except that the third method calculates the evaluation index using approximations of the evaluation index.

A still further example of these methods is disclosed in Y. LeCun, J. S. Denker, and S. A. Solla, “Optimal Brain Damage”, Advances in Neutral Information Processing Systems (NIPS), pp. 598-605, 1990, which will be referred to as a non-patent document 4.

The method, referred to as the fourth method, disclosed in the non-patent document 4 is designed to reduce connection weights of a multilayer neural network one by one, thus establishing an optimum network structure. Specifically, the fourth method uses the evaluation index based on the secondary differentiation of the cost function to thereby identify an unnecessary connection weight. The fourth method is therefore designed to be substantially identical to each of the first to third methods except for removal of a connection weight in place of a unit.

In contrast, Japanese Patent Publication No. 3757722 discloses another type of method from the first to fourth methods. Specifically, the disclosed method is designed to increase the number of output units in a hidden layer, i.e. an inter mediate layer, to optimize the number of units in the inter mediate layer if excessive learning has been carried out or learning of the optimum network structure of the multilayer neural network is not converged within the specified number of times of initial learning.

On the other hand, an image recognition method using CNN (Convolutional Neural Networks) is disclosed in Y. LeCun, B. Boser, J. S. Denker, D. Henderson, R. E. Howard, W. Hubbard, and L. D. Jacket, “Handwritten Digit Recognition with a Back-Propagation Network”, Advances in Neutral Information Processing Systems (NIPS), pp. 396-404, 1990, which will be referred to as a non-patent document 5.

### SUMMARY

There have been proposed no theories for describing which of structures of neural networks provide optimum generalization abilities when supervised data is given to the neural networks. The non-patent documents 1 to 3 introduce, as described above, so-called heuristic methods. These heuristic methods are commonly designed to train a neural network having relatively many weight parameters, such as connection weights, between units of the neural network first; and reduce some units in the units of the neural network in accordance with a given index, i.e. measure, for improving the generalization ability of the neural network.

For example, the index used in each of the non-patent documents 2 and 3 is a so-called pruning algorithm that selects units in hidden layers of a neural network to be removed, and removes them. How to select units to be removed is configured such that a new structure of the neural network from which the selected units have been removed has a minimum value of a cost function as compared with considerably all other structures of the neural network obtained by removing other units from the hidden layers.

In other words, the pruning algorithm removes units in hidden layers of a neural network; the removed units have lower contribution on reduction of the cost function with respect to training data.

After elimination of the selected units, training of the new structure having the remaining connection weights is restarted. That is, experience shows that maintenance of the remaining connection weights after removal of selected units provides a good generalization ability.

The pruning algorithm often provide neural networks having better generalization abilities as compared with those trained without using the pruning algorithm, and achieves a benefit of reduction of computation time required to establish the neural networks.

However, eliminating units in hidden layers of a neural network, which have lower contribution on reduction of the cost function with respect to training data, does not necessarily ensure an increase of the generalization ability of the neural network. This is because the cost function of a previous structure of a neural network after removal of units changes from that of a current structure of a neural network before removal of the units, and therefore, values of the connection weights of the previous structure may be not suitable for initial values of the connection weights of the current structure.

On the other hand, as described in the non-patent document 5, a structure of the CNN is manually determined. That is, there have been proposed no methods for automatically determining the structure of the CNN in view of improvement of the generalization ability of the CNN.

In view of the circumstances set forth above, one aspect of the present disclosure seeks to provide methods, systems, and program products for providing neural networks each having an improved structure having better simplicity and higher generalization ability.

According to a first exemplary aspect of the present disclosure, there is provided a method of obtaining an improved structure of a target neural network.

The method includes a first step of:

performing training of connection weights between a plurality of units included in an input structure of a target neural network using a first training-data set to thereby train the input structure of the target neural network; and

calculating a value of a cost function of a trained structure of the target neural network using a second training-data set separate from the first training-data set.

The training is continued until the calculated value of the cost function of a trained structure of the target neural network becomes a minimum value, the trained structure of the target neural network when the training is stopped being referred to as a candidate structure of the target neural network.

The method includes a second step of randomly removing at least one unit from the candidate structure of the target neural network to give a generated structure of the target neural network based on the random removal to the first step as the input structure of the target neural network, thus executing plural sequences of the first and second steps.

The method includes a third step of determining, for each of the sequences, whether the minimum value of the cost function of the candidate structure obtained by the first step of the sequence is lower than that of the cost function of the candidate structure obtained by the first step of a sequence immediately previous to the sequence.

When it is determined that the minimum value of the cost function of the candidate structure obtained by the first step of a specified-number sequence is lower than the minimum value of the cost function of the candidate structure obtained by the first step of a previous sequence immediately previous to the specified-number sequence, the method includes a fourth step of performing the second step of the specified-number sequence using the candidate structure obtained by the first step of the previous sequence.

When it is determined as a trigger determination that the minimum value of the cost function of the candidate structure obtained by the first step of a specified-number sequence is equal to or higher than the minimum value of the cost function of the candidate structure obtained by the first step of a previous sequence immediately previous to the specified-number sequence, the method includes a fifth step of performing, as the second step of the specified-number sequence, a step of randomly removing at least one unit from the candidate structure obtained by the first step of the previous sequence again, thus giving a new generated structure of the target neural network to the first step as the input structure of the target neural network, and performing the specified-number sequence again using the new generated structure of the target neural network.

According to a second exemplary aspect of the present disclosure, there is provided a system for obtaining an improved structure of a target neural network. The system includes a storage unit that stores therein a first training-data set and a second training-data set for training the target neural network, the second training-data set being separate from the first training-data set, and a processing unit.

The processing unit includes a training module. The training module performs a training process of:

training connection weights between a plurality of units included in an input structure of the target neural network using the first training-data set to thereby train the input structure of the target neural network; and

calculating a value of a cost function of a trained structure of the target neural network obtained for the training process using the second training-data set.

The training process is continued until the calculated value of the cost function of a trained structure of the target neural network becomes a minimum value. The trained structure of the target neural network when the training process is stopped is referred to as a candidate structure of the target neural network. The processing unit includes a removing module that:

performs a random removal process of randomly removing at least one unit from the candidate structure of the target neural network trained by the training unit to give a generated structure of the target neural network based on the random removal to the training unit as the input structure of the target neural network, thus executing plural sequences of the training process and removing process; and

determines, for each of the sequences, whether the minimum value of the cost function of the candidate structure obtained by the training process of the sequence is lower than the minimum value of the cost function of the candidate structure obtained by the training process of a sequence immediately previous to the sequence.

When it is determined that the minimum value of the cost function of the candidate structure obtained by the training process of a specified-number sequence is lower than the minimum value of the cost function of the candidate structure obtained by the training process of a previous sequence immediately previous to the specified-number sequence, the removing module performs the random removal process of the specified-number sequence using the candidate structure obtained by the training process of the previous sequence.

When it is determined as a trigger determination that the minimum value of the cost function of the candidate structure obtained by the training process of a specified-number sequence is equal to or higher than the minimum value of the cost function of the candidate structure obtained by the training step of a previous sequence immediately previous to the specified-number sequence, the removing module:

performs, as the removal process of the specified-number sequence, a random removal of at least one unit from the candidate structure obtained by the training process of the previous sequence again, thus giving a new generated structure of the target neural network to the training process as the input structure of the target neural network; and

performs the specified-number sequence again using the new generated structure of the target neural network.

According to a third exemplary aspect of the present disclosure, there is provided a program product usable for a system for obtaining an improved structure of a target neural network. The program product includes a non-transitory computer-readable medium; and a set of computer program instructions embedded in the computer-readable medium. The instructions cause a computer to:

perform a training process of:

training connection weights between a plurality of units included in an input structure of the target neural network using the first training-data set to thereby train the input structure of the target neural network; and

calculating a value of a cost function of a trained structure of the target neural network obtained for the training process using the second training-data set.

The training process is continued until the calculated value of the cost function of a trained structure of the target neural network becomes a minimum value, the trained structure of the target neural network when the training process is stopped being referred to as a candidate structure of the target neural network.

The instructions cause a computer to:

performs a random removal process of randomly removing at least one unit from the candidate structure of the target neural network trained by the training unit, thus giving a generated structure of the target neural network based on the random removal to the training unit as the input structure of the target neural network, thus executing plural sequences of the training process and removing process; and

determines, for each of the sequences, whether the minimum value of the cost function of the candidate structure obtained by the training process of the sequence is lower than the minimum value of the cost function of the candidate structure obtained by the training process of a sequence immediately previous to the sequence.

When it is determined that the minimum value of the cost function of the candidate structure obtained by the training process of a specified-number sequence is lower than the minimum value of the cost function of the candidate structure obtained by the training process of a previous sequence immediately previous to the specified-number sequence, the instructions cause a computer to perform the random removal process of the specified-number sequence using the candidate structure obtained by the training process of the previous sequence.

When it is determined as a trigger determination that the minimum value of the cost function of the candidate structure obtained by the training process of a specified-number sequence is equal to or higher than the minimum value of the cost function of the candidate structure obtained by the training step of a previous sequence immediately previous to the specified-number sequence, the instructions cause a computer to:

perform, as the removal process of the specified-number sequence, a random removal of at least one unit from the candidate structure obtained by the training process of the previous sequence again, thus giving a new generated structure of the target neural network to the training process as the input structure of the target neural network; and

perform the specified-number sequence again using the new generated structure of the target neural network.

As described in the methods of the non-patent documents 1 to 4, selection of units to be eliminated in hidden layers of a neural network based on reduction of a cost function of the neural network does not necessarily ensure an increase of the generalization ability of the neural network. To describe it simply, when a value of the cost function of a first structure of a neural network from which a unit “a” has been removed is lower than that of the cost function of a second structure of the neural network from which a unit “b” has been removed, the basic concept of the methods of the non-patent documents 1 to 4 speculates that training of the first structure of the neural network may obtain higher generalization ability as compared with training of the second structure thereof. However, this speculation is not necessarily satisfied.

In view of these circumstances, the inventors of the present application have a basic concept that:

which units) should be removed in a target neural network in order to improve the generalization ability of the target neural network will be known only when repetition of actual removal of unit(s) in the target neural network and training of a generated structure of the target neural network based on the removal of the unit(s) is carried out until early stopping occurs.

Specifically, each of the first to third exemplary aspects randomly removes at least one unit in the target neural network when the cost function of a trained structure thereof becomes a minimum value, i.e. overtraining occurs.

Specifically, when it is determined as a trigger determination that the minimum value of the cost function of the candidate structure obtained by the first step (training step) of a specified-number sequence is equal to or higher than the minimum value of the cost function of the candidate structure obtained by the first step of a previous sequence immediately previous to the specified-number sequence, each of the first to third exemplary aspects:

performs random removal of at least one unit from the candidate structure obtained by the first step of the previous sequence again, thus giving a new generated structure of the target neural network to the first step as the input structure of the target neural network; and

performs the specified-number sequence again using the new generated structure of the target neural network.

That is, plural executions, i.e. repeat executions, of random elimination of units and training of the candidate structure of the target neural network result in generation of a simpler structure of the target neural network while having higher generalization ability.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be construed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a view schematically illustrating a brief summary of a method for obtaining an improved structure of a target neural network according to a first embodiment of the present disclosure;

FIG. 2 is a graph schematically illustrating:

an example of a cost function obtained by repetitions of updating connection weights of a neural network using a first training-data set; and

an example of a cost function obtained by repetitions of updating connection weights of the same neural network using a second training-data set;

FIG. 3A is a view schematically illustrating an example of a trained initial structure of a target neural network according to the first embodiment;

FIG. 3B is a view schematically illustrating an example of a new structure of the target neural network obtained by removing some units from the trained initial structure of the target neural network according to the first embodiment;

FIG. 4 is a block diagram schematically illustrating an example of the structure of a system according to the first embodiment;

FIG. 5 is a flowchart schematically illustrating an example of specific steps of an optimizing routine carried out by a processing unit illustrated in FIG. 4 according to the first embodiment;

FIG. 6 is a flowchart schematically illustrating an example of specific steps of a subroutine of step S11 included in the optimizing routine illustrated in FIG. 5;

FIG. 7 is a view schematically illustrating a brief summary of a method for obtaining an improved structure of a target neural network according to a second embodiment of the present disclosure;

FIG. 8 is a flowchart schematically illustrating an example of specific steps of an optimizing routine carried out by the processing unit according to the second embodiment;

FIG. 9 is view schematically illustrating an example of the structure of a target convolution neural network to be optimized according to a third embodiment of the present disclosure;

FIG. 10 is a flowchart schematically illustrating an example of specific steps of an optimizing routine carried out by the processing unit according to the third embodiment;

FIG. 11 is a flowchart schematically illustrating an example of specific steps of an optimizing routine carried out by the processing unit according to a fourth embodiment of the present disclosure;

FIG. 12A is a graph schematically illustrating a first training-data set and a second training-data set used in an experiment that performs the method according to the second embodiment;

FIG. 12B is a view schematically illustrating an initial structure of a target neural network given to the method in the experiment; and

FIG. 13 is a table schematically illustrating the results of the experiment.

### DETAILED DESCRIPTION OF EMBODIMENT

Embodiments of the present disclosure will be described hereinafter with reference to the accompanying drawings. In the embodiments, like parts between the embodiments, to which like reference characters are assigned, are omitted or simplified in description to avoid redundant description.

### First Embodiment

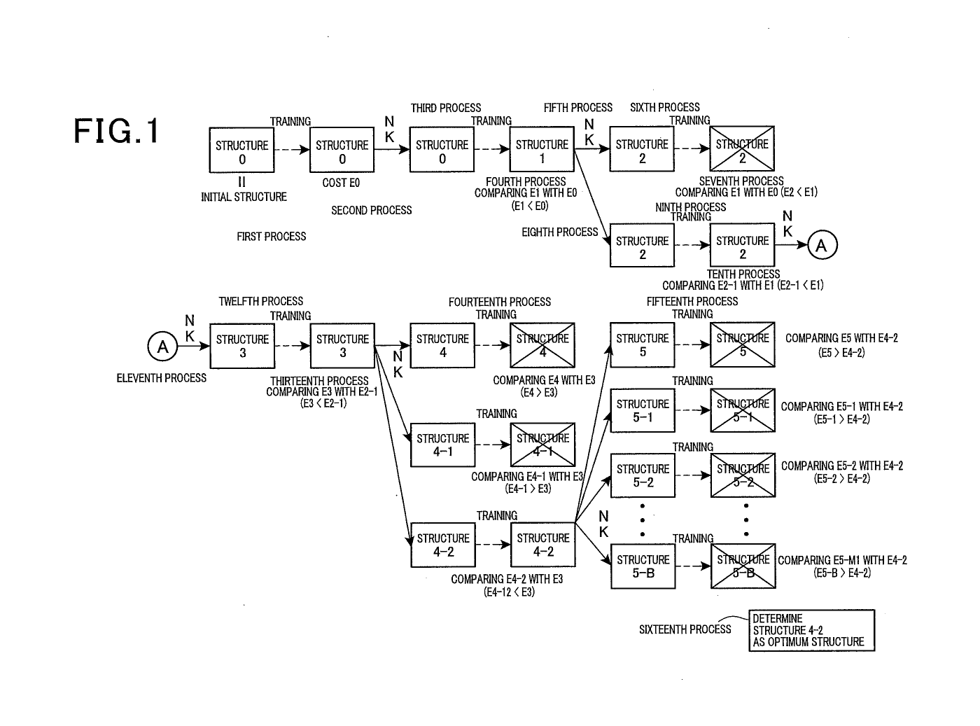

Referring to FIG. 1, there is illustrated a brief summary of a method for obtaining an improved structure of a target neural network according to a first embodiment of the present disclosure.

The method aims at a type of neural networks to be improved, i.e. optimized, according to the first embodiment. The type of neural networks is, for example, a multi-layer network comprised of an input layer, one or more intermediate layers, and an output layer; each of the layers includes plural units, i.e. neurons. Each unit, also called as node, serves as, for example, a functional module, such as a hardware module like a processor, a software module, or the combination of hardware and software modules. The multi-layer network is designed as, for example, a feedforward network in which signals are propagated from the input layer to the output layer.

The method according to the first embodiment includes, for example, the steps of: receiving an initial neural-network structure; and removing units from one or more inter mediate layers of the initial neural-network structure, thus achieving an optimum neural network.

The initial neural-network structure is designed to have, for example, a predetermined connection pattern among plural units in the input layer, plural units in at least one intermediate layer, i.e. at least one hidden layer, and plural units in the output layer.

In the initial neural-network structure, the connections, i.e. synapses, of units in one layer and units in another layer can be implemented. All units in one layer can be connected to each unit in a layer next thereto. Some units in one layer cannot be connected to at least one unit in a layer next thereto.

In the first embodiment, the initial neural-network structure is designed to include many units in each layer in order to eliminate units in the at least one inter mediate layer to obtain a suitable structure during execution of the method.

The initial neutral-network structure is illustrated as a structure 0 in FIG. 1. Values of connection weights, i.e. synapse weights, between units are initialized using random numbers following, for example, a normal distribution having an average of zero.

For example, when data values X₁ to Xₖ are input from first to k-th units to a target unit next to the first to k-th units while given connection weights W₁ to Wₖ are respectively set between the first to k-th units and the target unit and a bias W₀ is previously set, the target unit outputs a data value expressed as:

$$h ( {\sum }_{i = 0}^{k} {X}_{i} {W}_{i} )$$

where X₀ is equal to 1, and h(z) is a nonlinear activation function, such as a sigmoid function (1/(1^{-z}).

A first training-data set and a second training-data set are used in the neural network improving method according to the first embodiment.

The first training-data set is used to update connection weights between units of different layers to thereby obtain an updated structure of a target neural network. The second training-data set, which is completely separate from the first training-data set, is used to calculate costs of respective updated structures of the target neural network for evaluating the updated structures of the target neural network without being used for the update of the connection weights.

Each of the first and second training-data sets includes training data. The training data is comprised of: pieces of input data each designed as a multidimensional vector or a scalar; and pieces of output data, i.e. supervised data, designed as a multidimensional vector or scalar; the pieces of input data respectively correspond to the pieces of output data. That is, the training data is comprised of many pairs of input data and output data.

Note that the ratio of the size of the first training-data set to that of the second training-data set can be freely set. Preferably, the ratio of the size of the first training-data set to that of the second training-data set can be set to 1:1.

First, the method according to the first embodiment trains, i.e. learns, a target neural network with the structure 0 using the first training-data set. How to train neural networks will be described hereinafter. The method according to the first embodiment for example uses backpropagation, an abbreviation for “backward propagation of errors” as a known method and algorithm of training artificial neural networks. The backpropagation uses a computed output error to change values of the connection weights in backward direction.

Training the structure 0 of the target neural network using the backpropagation makes it possible to update the connection weights between the units. This results in: improvement of the accuracy rate of obtaining, as output data, desired supervised data corresponding to input data; and reduction of a value of a cost function for the trained structure of the target neural network. Note that the cost function for a neural network with respect to input data represents, for example, a known estimation index, i.e. measure, representing how far away output data of the neural network is from desired supervised data corresponding to the input data. For example, a means-square error function can be used as the cost function.

However, reduction of the cost function for a neural network with respect to input data contained in the first training-data set is not always compatible with improvement of a generalization ability of the corresponding neural network. Note that the generalization ability of a neural network means, for example, an ability of generating a suitable output when unknown data is input to the neural network.

That is, the aforementioned generalization ability is conceptually different from an ability of, when input data contained in the first training-data set is input to the neural network, obtaining, from the neural network, desired output data corresponding to the input data. Thus, even if the cost function of a neural network for the first training data set yields a desired result, the generalization ability of the neural network does not necessarily yield a desired result.

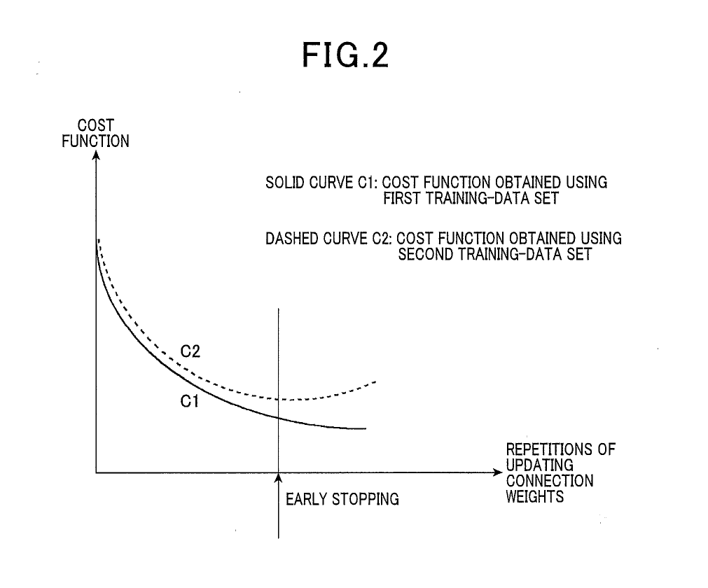

FIG. 2 schematically illustrates an example of the correlation between repetitions of updating the connection weights between: the units of a target neural network to be trained with respect to input data selected from the first training-data set; and a value of the cost function of the updated structure of the target neural network for each repetition.

As illustrated by solid curve C1, FIG. 2 shows that the cost function obtained using the first training-data set decreases with increase of repetitions of updating the connection weights.

FIG. 2 also schematically illustrates an example of the correlation between: repetitions of updating the connection weights between the units of the target neural network to be trained with respect to input data selected from the second training-data set; and a value of the cost function of the updated structure of the target neural network for each repetition.

FIG. 2 shows that, as illustrated by dashed curve C2, the cost function obtained using the second training-data set decreases with increase of repetitions of updating the connection weights between the units of the target neural network up to a predetermined number of the repetitions. FIG. 2 also shows that, after the predetermined number of the repetitions, the cost function for the second training-data set increases with increase of repetitions of updating the connection weights between the units of the target neural network (see the dashed curve C2). This phenomenon is referred to as overtraining. After the occurrence of the overtraining, the more the training of the target neural network is carried out, the lower the generalization ability of the target neural network is. The overtraining is likely to take place in training neural networks each including many units.

In order to prevent further training after the occurrence of overtraining, the method according to the first embodiment is designed to:

repeatedly perform training of a target neural network using the first training-data set;

calculate, using the second training-data set, a value of the cost function of a trained structure of the target neural network obtained for each training; and

stop training of the target neural network when the calculated value of the cost function of a current trained structure of the target neural network begins to increase.

Next, how to improve the structure of a neural network based on the method will be described hereinafter.

As described above, the method performs a first process of:

repeatedly performing training of the structure 0 of the target neural network using the first training-data set;

calculating a value of the cost function of a trained structure of the target neural network obtained for each training using the second training-data set; and

stopping training of the target neural network when the calculated value of the cost function of a current trained structure of the target neural network becomes a minimum value E0, in other words, starts to increase.

Specifically, the first process stops training of the target neural network having the structure 0 although the cost function of a current trained structure of the target neural network using the first training-data set is decreasing. Thus, the stopping of the training of the target neural network will be referred to as early stopping. The first process generates the trained structure 0 of the target neural network such that the connection weights between the units of the original structure 0 of the target neural network have been repeatedly updated as optimized or trained connection weights of the trained structure 0 of the target neural network.

Thus, the trained structure 0 and the corresponding trained, i.e. optimized, connection weights of the target neural network are obtained as a specific structure 0 and corresponding final connection weights of the target neural network at the zeroth stage of the method.

Next, the method performs a second process of randomly removing units from the one or more intermediate layers of the trained structure 0 of the target neural network. In FIG. 1, the second process of randomly removing units is illustrated by reference character NK (Neuron Killing), which means a process of killing, i.e. deleting, neurons. For example, as how to randomly removing units, the second process uses a method of deter mining one or more units that should be deleted based on a predetermined probability p for each unit; p is set to a value from the range from 0 (0%) to 1 (100%) inclusive. In other words, the probability of a unit being deleted at plural trials of removing process depends on a binomial distribution with a corresponding value of the probability p of the unit. The probability p will also be referred to as a unit deletion probability p.

Thus, the second process can simultaneously remove plural units from the one or more intermediate layers. The second process can determine one or more units that should be deleted using random numbers. The second process will also be referred to as a removal process.

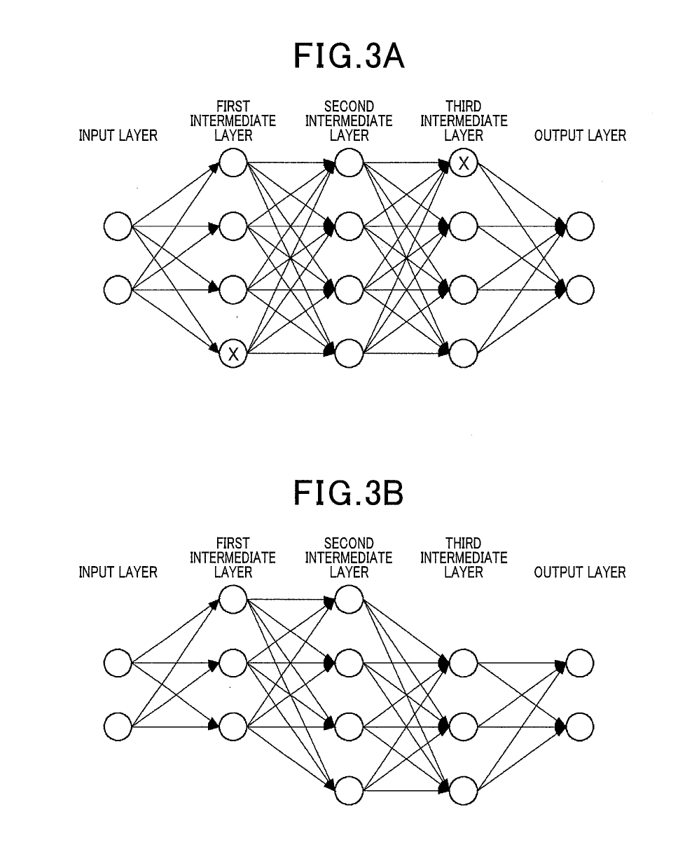

FIGS. 3A and 3B schematically illustrate how the structure of a neural network is changed when one or more units are deleted.

Specifically, FIG. 3A illustrates an example of the trained structure 0 of the target neural network comprised of the input layer, the first to third intermediate (hidden) layers, and the output layer. The input layer includes two units, each of the first to third intermediate layers includes three units, the output layer includes two units, and each unit in one layer is connected to all units in a layer next thereto. For example, each of four units in the first inter mediate layer is connected to all units in the second inter mediate layer. The trained structure 0 of the target neural network illustrated in FIG. 3A will be referred to as a 2-4-4-4-2 structure. As described above, the connection weights between different layers have been repeatedly trained, so that a value of the cost function of the trained structure 0 of the target neural network illustrated in FIG. 3A is minimized. For example, the method tries to remove units contained in the respective first and third units, to which label X is attached, from the trained structure 0 of the target neural network illustrated in FIG. 3A. After removal of the units X from the trained structure 0 of the target neural network illustrated in FIG. 3A, a new structure of the target neural network is generated as illustrated in FIG. 3B. Specifically, the input layer of the generated structure includes two units, the first intermediate layer includes three units, and the second intermediate layer includes four units. In addition, the third intermediate layer of the generated structure includes three units, and the output layer includes two units. Each unit in one layer of the generated structure is connected to all units in a layer next thereto. For example, each of three units in the third intermediate layer is connected to all units in the output layer. As illustrated in FIGS. 3A and 3B, after the units X, which should be randomly selected to be removed, have been removed from the trained structure 0 of the target neural network, all connections of the units X have also been removed. However, as illustrated in FIG. 3B, the trained connection weights between the remaining units of the generated structure are maintained.

As illustrated in FIG. 1, a new structure of the target neural network, which is generated by randomly removing units from the trained structure 0 of the target neural network, will be referred to as a structure 1.

Next, the method trains the structure 1 of the target neural network in the same approach as the training approach with respect to the structure 0 of the target neural network. As described above, the structure 1 of the target neural network inherits, i.e. takes over, the trained connection weights between the units of the trained structure 0, which correspond to the remaining units of the structure 1.

Specifically, the method performs a third process of:

repeatedly performing training of the structure 1 of the target neural network using the first training-data set;

calculating a value of the cost function of a trained structure of the target neural network obtained for each training using the second training-data set; and

stopping training of the target neural network when the calculated value of the cost function of a current trained structure of the target neural network becomes a minimum value E1.

Next, the method performs a fourth process of comparing the minimum value E1 of the cost function obtained from the trained structure 1 of the target neural network by the third process with the minimum value E0 of the cost function obtained from the trained structure 0 of the target neural network.

Assuming that, in the example illustrated in FIG. 1, the minimum value E1 of the cost function is lower than the minimum value E0 of the cost function, random remove of units in the structure 0 of the target neural network reduces the cost function of the target neural network. This results in an improvement of the generalization ability of the current structure, i.e. the trained structure 1, of the target neural network at the termination of the fourth process.

Thus, the trained structure 1 and the corresponding trained connection weights of the target neural network are obtained as a specific structure 1 and corresponding specific connection weights of the target neural network at the first stage of the method.

Following the fourth process, the method performs a fifth process of randomly removing units from the one or more intermediate layers of the trained structure 1 of the target neural network in the same approach as the second process, thus generating a new structure 2 of the target neural network.

Next, the method performs a sixth process of:

repeatedly performing training of the structure 2 of the target neural network using the first training-data set;

calculating a value of the cost function of a trained structure of the target neural network obtained for each training using the second training-data set; and

stopping training of the target neural network when the calculated value of the cost function of a current trained structure of the target neural network becomes a minimum value E2.

Following the sixth process, the method performs a seventh process of comparing the minimum value E2 of the cost function obtained from the trained structure 2 of the target neural network by the sixth process with the minimum value E1 of the cost function obtained from the trained structure 1 of the target neural network. Assuming that, in the example illustrated in FIG. 1, the minimum value E1 of the cost function is lower than the minimum value E2 of the cost function, the method determines that the generalization ability of the structure 2 of the target neural network is lower than that of the structure 1 thereof.

Thus, after determination based on the results of the seventh process, the method is designed not to determine the trained structure 2 of the target neural network as a specific structure 2 at the second stage.

Specifically, the method performs an eighth process of performing random removal of units from the one or more inter mediate layers of the previous trained structure of the target neural network, i.e. the trained structure 1 thereof, again in the same approach as the second process, thus generating a new structure 2-1 of the target neural network. Then, the method performs a ninth process of:

repeatedly performing training of the structure 2-1 of the target neural network using the first training-data set;

calculating a value of the cost function of a trained structure of the target neural network obtained for each training using the second training-data set; and

stopping training of the target neural network when the calculated value of the cost function of a current trained structure of the target neural network becomes a minimum value E2-1.

Following the ninth process, the method performs a tenth process of comparing the minimum value E2-1 of the cost function obtained from the trained structure 2-1 of the target neural network by the ninth process with the minimum value E1 of the cost function obtained from the trained structure 1 of the target neural network. Assuming that, in the example illustrated in FIG. 1, the minimum value E2-1 of the cost function is lower than the minimum value E1 of the cost function, the method determines that the generalization ability of the trained structure 2-1 of the target neural network is improved as compared with that of the structure 1 thereof.

Thus, the trained structure 2-1 and the corresponding trained, i.e. optimized, connection weights of the target neural network are obtained as a specific structure 2 and corresponding specific connection weights of the target neural network at the second stage of the method.

Then, the method performs an eleventh process of randomly removing units from the one or more intermediate layers of the trained structure 2-1 of the target neural network in the same approach as the second process, thus generating a new structure 3 of the target neural network.

Next, the method performs a twelfth process of:

repeatedly performing training of the structure 3 of the target neural network using the first training-data set;

calculating a value of the cost function of a trained structure of the target neural network obtained for each training using the second training-data set; and

stopping training of the target neural network when the calculated value of the cost function of a current trained structure of the target neural network becomes a minimum value E3.

After the twelfth process, the method performs a thirteenth process of comparing the minimum value E3 of the cost function obtained from the trained structure 3 of the target neural network by the twelfth process with the minimum value E2-1 of the cost function obtained from the trained structure 2-1 of the target neural network.

Assuming that, in the example illustrated in FIG. 1, the minimum value E3 of the cost function is lower than the minimum value E2-1 of the cost function, random removal of units in the trained structure 2 of the target neural network reduces the cost function of the target neural network. This results in an improvement of the generalization ability of the target neural network at the termination of the thirteenth process.

Thus, the trained structure 3 and the corresponding trained connection weights of the target neural network are obtained as a specific structure 3 and corresponding specific connection weights of the target neural network at the third stage of the method.

After the thirteenth process, the method performs the following fourteenth process in the same approaches as the fifth to tenth processes:

Specifically, the method performs:

(i) random removal of units from the trained previous structure, i.e. the trained structure 3, of the target neural network;

(ii) training of a generated structure of the target neural network after random removal of units;

(iii) determination of whether a minimum value of the cost function of the generated structure of the target neural network is lower than the minimum value of the cost function of the trained structure 3 of the target neural network; and

(iv) repetition of the steps (i) to (iii) until it is determined in the step (iii) that a minimum value of the cost function of the generated structure of the target neural network is lower than the minimum value of the cost function of the trained structure 3 of the target neural network.

Specifically, as illustrated in FIG. 1, the method performs random removal of units from the one or more intermediate layers of the trained structure 3 of the target neural network, and performs training of a generated structure, i.e. a structure 4, of the target neural network after removal of random units. In the example illustrated in FIG. 1, it is assumed that the minimum value E3 of the cost function of the trained structure 3 is lower than a minimum value E4 of the cost function of the trained structure 4 thereof. The set of steps (i) to (iii) will be referred to as a training process.

Thus, the method performs random removal of units from the one or more intermediate layers of the previous trained structure 3 of the target neural network again, and performs training of a generated structure, i.e. a structure 4-1, of the target neural network after removal of random units.

As illustrated in FIG. 1, it is assumed that the minimum value E3 of the cost function is also lower than a minimum value E4-1 of the cost function of the trained structure 4-1 thereof. Thus, the method performs random removal of units from the one or more inter mediate layers of the previous trained structure 3 of the target neural network again, and performs training of a generated structure, i.e. a structure 4-2, of the target neural network after removal of random units.

At that time, it is assumed that a minimum value E4-2 of the cost function of the generated structure, i.e. the trained structure 4-2, of the target neural network is lower than the minimum value E3 of the cost function of the trained structure 3 thereof. Thus, the method determines that the generalization ability of the trained structure 4-2 of the target neural network is improved as compared with that of the trained structure 3 thereof. This results in the trained structure 4-2 and the corresponding trained connection weights of the target neural network being obtained as a specific structure 4-2 and corresponding specific connection weights of the target neural network at the fourth stage of the method.

Then, the method performs the following fifteenth process in the same approach as the fourteenth process.

Specifically, the method performs:

(i) random removal of units from the trained previous structure, i.e. the trained structure 4-2, of the target neural network;

(ii) training of a generated structure of the target neural network after random removal of units;

(iii) determination of whether a minimum value of the cost function of the generated structure of the target neural network is lower than the minimum value of the cost function of the trained structure 4-2 of the target neural network; and

(iv) repetition of the steps (i) to (iii) until it is determined in the step (iii) that a minimum value of the cost function of the generated structure of the target neural network is lower than the minimum value of the cost function of the trained structure 4-2 of the target neural network.

Specifically, as illustrated in FIG. 1, the method performs random removal of units from the one or more inter mediate layers of the trained structure 4-2 of the target neural network, and performs training of a generated structure, i.e. a structure 5, of the target neural network after removal of random units. In the example illustrated in FIG. 1, it is assumed that the minimum value E4-2 of the cost function of the trained structure 4-2 is lower than a minimum value E5 of the cost function of the trained structure 5 thereof.

After determination that the minimum value E4-2 of the cost function is lower than the minimum value E5 of the cost function, the method performs repeats of the steps (i) to (iii) at a preset upper-limit number B of times.

However, although the steps (i) to (iii) have been carried out at the upper-limit number B of times, the minimum value E4-2 of the cost function of the trained structure 4-2 is lower than all the minimum values E5-1, E5-2, . . . , and E5-B of the respective cost functions of the trained structures 5-1, 5-2, . . . , and 5-B (see FIG. 1). At that time, the method performs a sixteenth process of deter mining that the trained structure 4-2 of the target neural network is an optimum structure of the target neural network.

Next, a detailed structure of the method of obtaining an improved structure of a target neural network according to the first embodiment, and a detailed structure of a system 1 for obtaining the same will be described hereinafter.

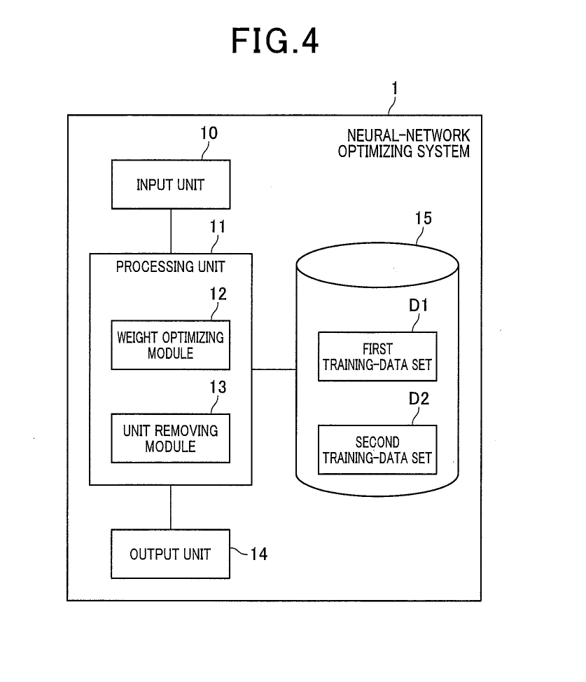

FIG. 4 schematically illustrates an example of the detailed structure of the system 1.

The system 1 includes, for example, an input unit 10, a processing unit 11, an output unit 14, and a storage unit 15.

The input unit 10 is communicably connected to the processing unit 11, and is configured to input, to the processing unit 11, data indicative of an initial structure of a target neural network to be optimized. For example, the input unit 10 is configured to: permit a user to input data indicative of the initial structure of the target neutral network thereto; and input the data to the processing unit 11.

The processing unit 11 is configured to receive the data indicative of the initial structure of the target neural network input from the input unit 10, and perform the method of optimizing the initial structure of the target neural network based on the received data. More specifically, the processing unit 11 is configured to perform calculations of optimizing the initial structure of the target neural network received by the input unit 10.

The output unit 14 is communicably connected to the processing unit 11, and is configured to receive an optimum structure of the target neural network sent from the processing unit 11. Then, the output unit 14 is configured to visibly or audibly output the optimum structure of the target neural network.

The storage unit 15 is communicably connected to the processing unit 11. The storage unit 15 is configured to previously store therein a first training-data set D1 and a second training-data set D2 described above; the first and second training-data sets D1 and D2 are used for the processing unit 11 to perform optimization of the initial structure of the target neural network. The processing unit 11 can be configured to store the optimum structure of the target neural network in the storage unit 15.

The system 1 according to the first embodiment can be designed as, for example, a computer comprised of, for example, a CPU, an I/O unit to which various input devices and various output units are connectable, a memory including a ROM and/or a RAM, and so on. If the system 1 is designed as such a computer, the CPU serves as the processing unit 11, the I/O unit serves as the input and output units and one or more input and/or output devices connected thereto. The memory serves as the storage unit 15. A set of computer program instructions can be stored in the storage unit 15, and can instruct the processing unit 11, such as a CPU, to perform predetermined operations, thus optimizing the initial structure of the target neural network.

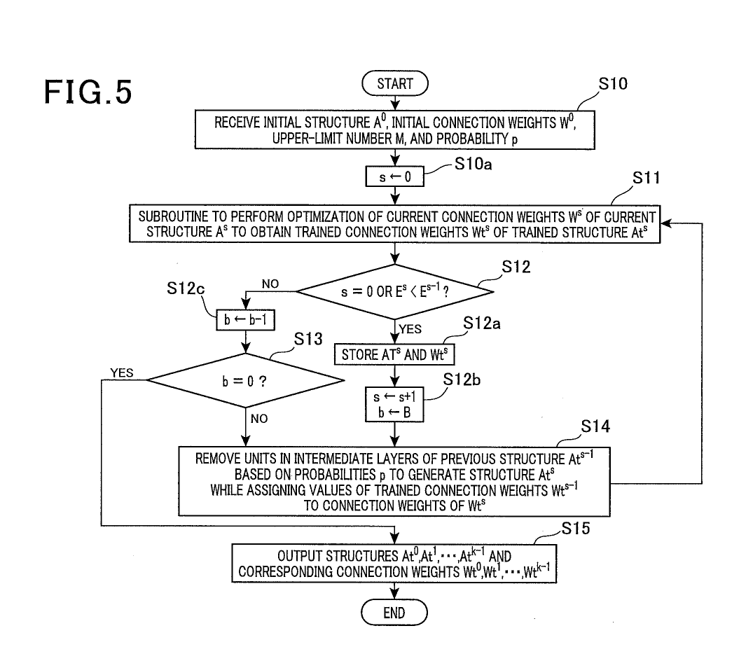

FIG. 5 schematically illustrates an example of specific steps of an optimizing routine, which is carried out by the processing unit 11, corresponding to the aforementioned method of optimizing an initial structure of a target neural network according to the first embodiment.

When data indicative of an initial structure A⁰ of a target neural network is input to the processing unit 11 from the input unit 10, the processing unit 11 receives the data indicative of the initial structure A⁰ of the target neural network in step S10. The initial structure A⁰ of the target neural network includes initial connection weights W⁰ between units included therein.

In addition, when data indicative of a preset upper-limit number B is input to the processing unit 11 from the input unit 10, the processing unit 11 receives the data indicative of the preset upper-limit number B in step S10. As described above, the preset upper-limit number B represents a condition for stopping the optimizing routine.

Moreover, when data indicative of a value of the unit deletion probability p for each unit, which is selected from the range from 0 (0%) to 1 (100%) inclusive, is input to the processing unit 11 from the input unit 10, the processing unit 11 receives the data in step S10. An increase in the value of the unit deletion probability p for each unit increases the number of units that should be deleted for each removal process set forth above. In contrast, a decrease in the value of the unit deletion probability p for each unit decreases the number of units that should be deleted for each removal process.

Following the operations in step S10, the processing unit 11 uses a declared variable s for indicating the number of times of deleting units, in other words, a current stage of the optimizing routine, and sets the variable to an initial value of 0 in step S10a. At that time, a current structure of the target neural network is represented as A^{s}, and current connection weights between units included in the current structure A^{s} is represented as W^{s}. That is, because the variable s is set to 0, the current structure A^{s} of the target neural network shows the initial structure A⁰, and the current connection weights W^{s} between units included in the current structure A^{s} show the initial connection weights W⁰.

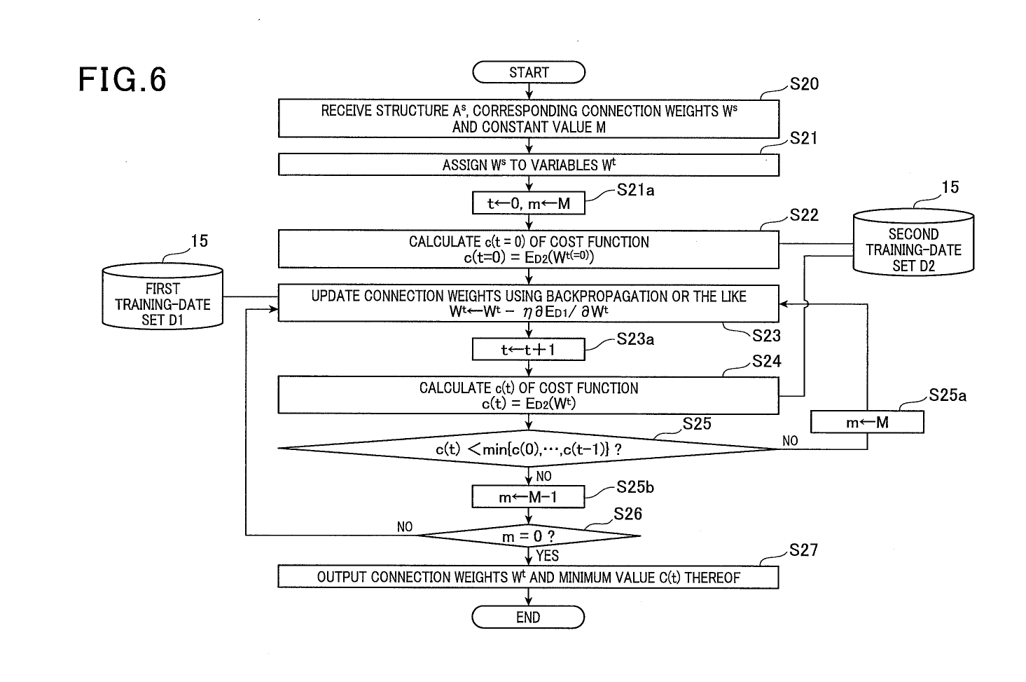

Next, the processing unit 11 performs optimization of the current connection weights W^{s} of the current structure A^{s}, thus obtaining optimized, i.e. trained, connection weights Wt^{s} of a trained structure At^{s}, and a minimum value E^{s} of the cost function of the trained structure At^{s} in step S11. The subroutine in step S11 for optimizing the current connection weights W^{s} of the current structure A^{s} will be described later with reference to FIG. 6. A processing module for performing the subroutine in step S11 will be referred to as a weight optimizing module 12, and the weight optimizing module 12 is included in the processing unit 11 as illustrated in FIG. 4.

Following the subroutine in step S11, the processing unit 11 determines whether to continue training of the target neural network based on removal of units included in the trained structure At^{s} in step S12. Specifically, the processing unit 11 determines whether the variable s is set to 0 or the minimum value E^{s} of the cost function of the trained structure At^{s} is lower than a previous minimum value E^{s-1} of the cost function of a previous trained structure At^{s-1}, which will be simply expressed as relation E^{s}<E^{s-1}, in step S12.

In step S12, the determination of whether the variable s is set to 0 shows whether the trained structure At^{s} is a trained structure At⁰ of the initial structure A⁰. That is, if the variable s is set to 0, the minimum value E^{s} of the cost function of the trained structure At^{s} is a minimum value E⁰ of the cost function of the trained structure At⁰ of the initial structure A⁰. Thus, there is no previous minimum value E^{s-1} of the cost function of a previous trained structure At^{s-1}.

When the variable s is set to 0 (the determination in step S12 is YES), the optimizing routine proceeds to step S12a. In step S12a, the processing unit 11 stores the trained structure At^{s} and the corresponding trained connection weights Wt^{s} in the storage unit 15 as a specific structure At⁰ and the corresponding specific connection weights Wt⁰ at the zeroth stage of the optimizing routine in step S12a because the variable s is set to 0.

Next, the processing unit 11 increments the variable s by 1, and initializes a declared variable b, thus substituting the upper-limit number B into the variable b in step S12b. Thereafter, the optimizing routine proceeds to step S14.

In addition, in step S12, the deter ruination of whether the relation E^{s}<E^{s-1} is satisfied shows whether the minimum value E^{s} of the cost function of the trained structure At^{s}, which has been obtained by removing units from the previous trained structure At^{s-1}, is lower than the previous minimum value E^{s-1} of the cost function of the previous trained structure At^{s-1}.

Upon determination that the relation E^{s}<E^{s-1} is satisfied (YES in step S12), the processing unit 11 executes the operations in steps S12a and S12b set forth above. Particularly, the operation in step S12a stores the trained structure At^{s} and the corresponding trained connection weights Wt^{s} in the storage unit 15 as a specific structure At^{s} and the corresponding candidate connection weights Wt^{s} at a current s-th stage of the optimizing routine. In addition, the operation in step S12b increments the current stage s of the optimizing routine by 1, and initializes the variable b to the upper-limit number B.

Thereafter, the optimizing routine proceeds to step S14.

In step S14, the processing unit 14 removes units in one or more intermediate layers, i.e. hidden layers, of the previous trained structure At^{s-1} based on the values of the unit deletion probability p for all the respective units included in the previous trained structure At^{s-1}, thus generating a structure A^{s} of the target neural network. A processing module for performing the operation in step S14 will be referred to as a unit removing module 13, and the unit removing module 13 is included in the processing unit 11 as illustrated in FIG. 4.

In step S14, the processing unit 11 assigns values of the trained connection weights Wt^{s-1} of the previous trained structure At^{s-1} to corresponding values of connection weights W^{s} of the structure A^{s}. This results in the structure A^{s} of the target neural network inheriting, i.e. taking over, the trained connection weights Wt^{s-1} of the previous trained structure At^{s-1} as they are.

Otherwise, it is determined that the variable s is unset to 0 and the relation E^{s}<E^{s-1} is unsatisfied (NO in step S12).

The negative determination in step S12 means that the minimum value E^{s} of the cost function of the trained structure At^{s}, which has been obtained by removing units from the previous trained structure At^{s-1}, is equal to or higher than the previous minimum value E^{s-1} of the cost function of the previous trained structure At^{s-1}. That is, the processing unit 11 determines that the generalization ability of the previous trained structure At^{s-1} is higher than that of the trained structure At^{s}.

Then, the processing unit 11 decrements the variable b by 1 in step S12c, and determines whether the variable b is zero in step S13. When it is determined that the variable b is not zero (NO in step S13), the optimizing routine proceeds to step S14.

In step S14, as described above, the processing unit 11 removes units in one or more inter mediate layers of the previous trained structure At^{s-1} based on the values of the unit deletion probability p for all the respective units included in the previous trained structure At^{s-1}, thus generating a structure A^{s} of the target neural network.

After the operation in step S14, the optimizing routine returns to step S11. Then, the processing unit 11 performs, as described above, optimization of the current connection weights W^{s} of the current structure A^{s}, thus obtaining trained connection weights Wt^{s} of a trained structure At^{s}, and a minimum value E^{s} of the cost function of the trained structure At^{s} in step S11.

Specifically, the processing unit 11 repeats a first sequence of the operations in steps S11, S12, S12a, S12b, and S14 while:

storing, for each current stage s, a corresponding specific structure At^{s} and connection weights Wt^{s};

incrementing, after the store, the stage by 1; and

initializing the variable b to the upper-limit number B (see the third and fourth processes, and the twelfth and thirteenth processes in FIG. 1).

That is, the first sequence corresponds to the flow of change of the structure of the target neural network from the structure 0, the structure 1, the structure 2-1, the structure 3, and the structure 4-2 (see FIG. 1).

During repetition of the first sequence, at a current stage s, if the determination in step S12 is NO, the processing unit 11 repeats a second sequence of the operations in steps, S13, S14, S11, and S12. Specifically, the processing unit 11 repeats the second sequence while keeping the current stage s not incremented until the determination in step S13 is negative (see, for example, the sixth process and the fourteenth process in FIG. 1).

During repetition of the second sequence, if the determination in step S12 is affirmative, the processing unit 11 stores a corresponding specific structure At^{s} and corresponding specific connection weights Wt^{s}, increments, after the store, the current stage by 1, and initializes the variable b to the upper-limit number B. Thereafter, the processing unit 11 returns to the first sequence from the operation in step S14.

Otherwise, during repetition of the second sequence, let us consider the determination in step S13 is affirmative. Specifically, let us consider a situation where B-times repeats of the second sequence cannot reduce the respective minimum values E^{s} of the cost functions of the trained structures At^{s} as compared with the previous minimum value E^{s-1} of the cost function of the previous trained structure At^{s-1} (see the fifteenth process in FIG. 1).

In this situation, the processing unit 11 determines termination of the optimizing routine of the target neural network. That is, the variable b serves as a counter, and the counter b and the upper-limit value B therefor serve to determine whether to stop the optimizing of the target neural network. Following the affirmative determination in step S14, the optimizing routine proceeds to step S15. Note that, at the time of the affirmative determination in step S14, the variable s indicative of the current stage of the optimizing routine is set to k; k is an integer equal to or higher than 2.

In step S15, the processing unit 11 outputs the specific structures At⁰ At⁰, At¹, . . . , At^{k-1}, and corresponding specific connection weights Wt⁰, Wt¹, Wt^{k-1} stored in the storage unit 15 via the output unit 14.

Next, the subroutine in step S11 for optimizing the current connection weights W^{s} of the current structure A^{s} will be described hereinafter with reference to FIG. 6.

When the subroutine is called by the main routine, i.e. the optimizing routine, in step S20 of FIG. 6, the weight optimizing module 12 receives the current structure A^{s}, that is, a target structure A^{s}, and the corresponding current connection weights W^{s} given from the operation in step S10 or that in step S14. In step S20, the weight optimizing module 12 receives a constant value M, which is input via the input unit 10 or is loaded from the storage unit 15.

Next, the weight optimizing module 12 expresses the current connection weights W^{s} as connection weights W^{s} using a declared variable t in step S21. Following step S21, the weight optimizing module 12 initializes the variable t to 0, and initializes a declared variable m to the constant value M in step S21a.

Next, the weight optimizing module 12 calculates a value c(t=0) of the cost function of the connection weights W^{t(=0)} using the second training-data set D2 in step S22. The value c(t=0) of the cost function of the connection weights W^{t(=0)} is represented as the following equation [1]:

c(t=0)=E_{D2}(W^{t(=0)}) [1]

where E_{D2}(W^{t}) represents an example of the cost function representing an estimation index of the connection weights W^{t} using the second training-data set D2. Specifically, the cost function E_{D2}(W^{t}) represents a function indicative of an error between, when data in the second training-data set D2 is input to the current structure A^{s} having the connection weights W^{t} as input data, corresponding supervised data and output data output from the output layer of the target structure A^{s}.

Following step S22, the weight optimizing module 12 updates the connection weights Wt^{t} of the target structure A^{s} in accordance with the backpropagation or another similar method using the first training-data set D1 in step S23. For example, the weight optimizing module 12 updates the connection weights W^{t} based on the following equation:

$${W}^{t} ← {W}^{t} - η \frac{\partial {E}_{D 1}}{\partial {W}^{t}} \qquad [ 2 ]$$

where:

E_{D1}(W^{t}) represents a cost function indicative of an error between, when data in the first training-data set D1 is input to the current structure A^{s} having the connection weights W^{t} as input data, corresponding supervised data and output data output from the output layer of the target structure A^{s};

$$\frac{\partial {E}_{D 1}}{\partial {W}^{t}}$$

represents the partial differential of the cost function E_{D1}(W^{t}) with respect to connection weights W^{t}, i.e. change of the cost function E_{D1}(W^{t}) with respect to the connection weights W^{t}; and

η represents a training coefficient indicative of an amount of change of the connection weights W^{t} per one training in step S23.

That is, the equation [2] represents change of the connection weights W^{t} to reduce the cost function E_{D1}(W^{t}).

Next, the weight optimizing module 12 increments the variable t by 1 in step S23a, and calculates a value c(t) of the cost function E_{D1}(W^{t}) of the connection weights W^{t} using the second training-data set D2 in step S24. The value c(t) of the cost function E_{D2}(W^{t}) of the connection weights W^{t} is represented as the following equation:

c(t)=E_{D2}(W^{t})

Following step S24, the weight optimizing module 12 determines whether the value c(t) of the cost function E_{D2}(W^{t}) calculated in step S24 is lower than all values c(0), c(t−1) in step S25; these values c(0), . . . , c(t−1) have been calculated in steps S22 and S24. In other words, the weight optimizing module 12 determines whether the value c(t) of the cost function E_{D1}(W^{t}) calculated in step S24 is lower than a value of the function min [c(0), . . . , c(t−1)]; the value of the function min [c(0), . . . , c(t−1)] is minimum one of all the values c(0), . . . , c(t−1).

When it is determined that the value c(t) is lower than all the values c(0), . . . , c(t−1) (YES in step S25), the weight optimizing module 12 initializes the variable m to the constant value M in step S25a. Then, the weight optimizing module 12 returns to step S23, and repeats the operations in steps S23 to S25 including updating of the connection weights W^{t} while, for example, changing the input value to another value in the first training-data set D1.

On the other hand, when it is determined that the value c(t) is equal to or higher than all the values c(0), . . . , c(t−1) (NO in step S25), the weight optimizing module 12 decrements the variable m by 1 in step S25b.

Next, the weight optimizing module 12 determines whether the variable m is zero in step S26. When it is determined that the variable m is not zero (NO in step S26), the weight optimizing module 12 returns to step S23, and repeats the operations in steps S23 to S26 including updating of the connection weights W^{t} while, for example, maintaining the input value.

Otherwise, when it is determined that the variable m is zero (YES in step S26), the weight optimizing module 12 determines that M-times updating of the connection weights Wt cannot update the current minimum value c(x) of the cost function in all the values c(0), . . . , c(t−1); the value x is one of all the values c(0), . . . , c(t−1). Then, the weight optimizing module 12 outputs the connection weights W^{t(=x)} of the target structure A^{s} and the minimum value c(x) of the cost function as trained connection weights Wt^{s} of a trained structure At^{s} and a minimum value E^{s} of the cost function of the trained structure At^{s} in step S27. Thereafter, the weight optimizing module 12 returns to step S12, and performs the next operations in step S12 to S15 set forth above.

Next, advantages achieved by the method and system 1 for obtaining an improved structure of a neural network according to the first embodiment will be described hereinafter.

Various networks including neural networks include many units having, as unknown parameters, connection weights therebetween. If the number of the unknown parameters of a neural network trained with respect to training data is larger than that of parameters of the trained neural network, which are required to generate a true output-data distribution, there may be overfitting, i.e. overtraining, of the trained neural network with respect to the training data. In multilayer neural networks, although the number of parameters depends on the number of units, it has been difficult to suitably determine the number of units in each layer.

In contrast, the method and system 1 for obtaining an improved structure of a neural network according to the first embodiment are configured to train an initial structure of a target neural network, and remove units in one or more intermediate layers, i.e. hidden layers, when overtraining occurs during the training, thus removing connection weights of the removed units, i.e. parameters thereof. Usually, after the occurrence of the overtraining, the more the training of the target neural network is carried out, the less the generalization ability of the target neural network is reduced. For this reason, removal of units in the target neural network at the occurrence of overtraining during the training according to the first embodiment is reasonable for obtaining an improved structure of the target neural network in view of improvement of its generalization ability.

In a neural network, it is very difficult to quantify how much each unit is subject to overtraining. This is because input signals to a target unit have high-level correlations with respect to a plurality of units connected to the target unit, so that it is difficult to separate only the characteristics of the input signals to a unit from the neural network. This also can be rephrased that the features of input signals to a unit are held in input and/or output signals to and/or from other units. For example, each of the non-patent documents 1 to 4 discloses a method of removing units one by one, which may be suitable for improvement of the structure of neural networks.

In view of the aforementioned fact, in order to remove redundant features in a target neural network, the aforementioned method according to the first embodiment for simultaneously eliminating plural units is efficient. That is, simultaneous removal of units from a target neural network in which input signals to each unit have high-level correlations with respect to a plurality of units connected to the corresponding unit make it possible to efficiently eliminate units in the target neural network.

Note that the non-patent document 2 discloses, that is, a round-robin method for removing units in a target neural network. For example, assuming that the target neural network includes N units, i.e. neurons, removal of units one by one from the target neural network using the round-robin method may require N trials. Removal of m units for each trial from the target neural network may require order of N^{m} trials, which is a huge number of trials. It therefore may be difficult to remove units from the target neural network using the method disclosed in the non-patent document.

The method and system 1 for obtaining an improved structure of a neural network according to the first embodiment are configured to:

perform training of a structure of the target neural network, generated after removal of units, using the first training-data set D1;

calculating a value of the cost function of a trained structure of the target neural network using the second training-data set D2; and

stopping training of the target neural network when the calculated value of the cost function of a current trained structure of the target neural network becomes a minimum value, in other words, starts to increase representing the occurrence of overtraining.

This configuration reliably reduces values of the cost function of respective trained structures of the target neural network with respect to the second training-data set D2, and prevents redundant training after the occurrence of overtraining, thus improving the generalization ability of the target neural network while reducing an amount of calculation required to perform the training. This configuration also makes it possible to automatically determine an optimum structure of the target neural network. Particularly, the automatic determination of an optimum structure of the target neural, network results in reduction of complexity of optimizing the structure of the target network. The reason is as follows. Specifically, in order to improve the generalization ability of a target multilayer neural network, it is very difficult to manually adjust the number of units in one or more hidden layers in the target multilayer neural network because of the enormous amount of combinations between units in each layer.

The method and system 1 for obtaining an improved structure of a neural network according to the first embodiment are configured to randomly remove units from a trained structure of the target neural network in accordance with a binomial distribution with the unit deletion probability p for each unit. This configuration makes it possible to:

try to eliminate different patterns of combinations of units; and

reduce, by virtue of the simple distribution, the number of hyperparameters, which determine the structures of the units in the target neural network, in addition to the number of units in each intermediate layer.

### Second Embodiment

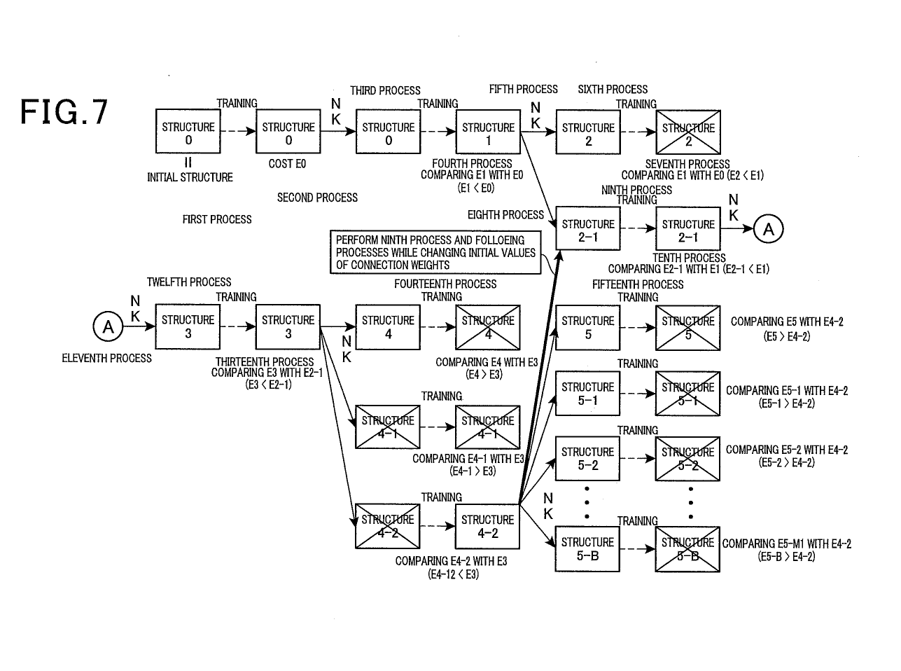

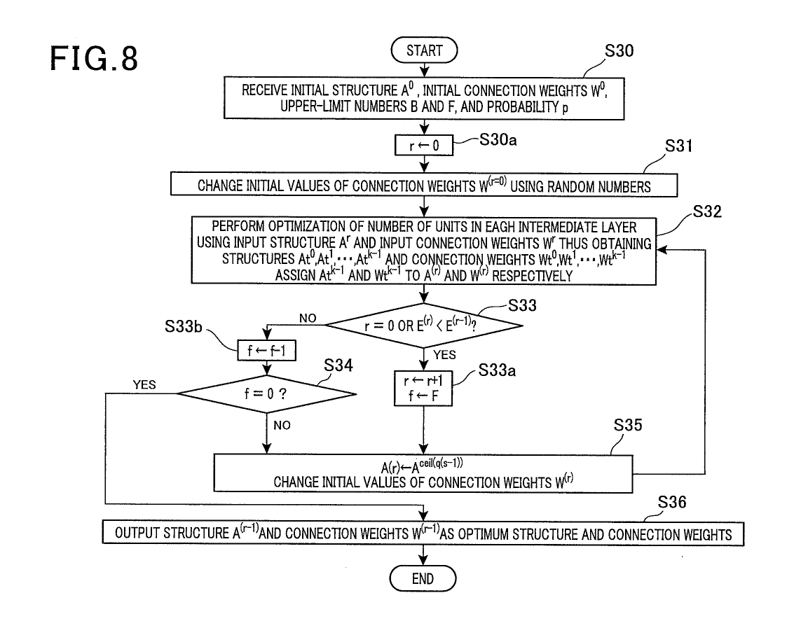

A method and a system for obtaining an improved structure of a target neural network according to a second embodiment of the present disclosure will be described hereinafter with reference to FIGS. 7 and 8. How the target neural network is optimized depends on initial values of the connection weights between units of the target neural network. Thus, the method and the system according to the second embodiment are configured to change initial values of the connection weights using random numbers at plural times in the same manner as the operation that performs removal of randomly selected units at plural times when the determination in step S12 is negative. This configuration aims to reduce the dependency of how the target neural network is optimized on initial values of the connection weights.

FIG. 7 is a diagram schematically illustrating a brief summary of the method for obtaining an improved structure of a target neural network according to the second embodiment of the present disclosure.

The basic flow of processing of the method according to the second embodiment illustrated in FIG. 7 is substantially identical to that of processing of the first embodiment illustrated in FIG. 1.

Particularly, after determination that the minimum value E4-2 of the cost function is lower than the minimum value E5 of the cost function, the method returns to the previous structure obtained at one or more stages before the current stage. For example, in FIG. 7, the method returns to the previous structure 2-1 two stages before the current fourth stage. Then, the method changes initial values of the connection weights of the structure 2-1 using random numbers, and continuously performs the ninth process and the following processes.

Next, a detailed structure of the method and the system according to the second embodiment will be described hereinafter.

Because the structure of the system according to the second embodiment is substantially identical to that of the system 1 according to the first embodiment, descriptions of which are omitted or simplified.

FIG. 8 schematically illustrates an example of specific steps of an optimizing routine, which is carried out by the processing unit 11, corresponding to the aforementioned method according to the second embodiment.

When data indicative of an initial structure A⁰ of a target neural network is input to the processing unit 11 from the input unit 10, the processing unit 11 receives the data indicative of the initial structure A⁰ of the target neural network in step S30. The initial structure A⁰ of the target neural network includes connection weights W⁰ between units included therein.

When data indicative of the upper-limit number B is input to the processing unit 11 from the input unit 10, the processing unit 11 receives the data indicative of the upper-limit number B in step S30.

In addition, when data indicative of a preset upper-limit number F is input to the processing unit 11 from the input unit 10, the processing unit 11 receives the data indicative of the preset upper-limit number F in step S30. As described in the first embodiment, the preset upper-limit number F represents a condition for stopping the optimizing routine.

When data indicative of a value q is input to the processing unit 11 from the input unit 10, the processing unit 11 receives the data indicative of the value q in step S30. The value q, which is selected from the range from 0 to 1 inclusive, shows a number of stages; the optimizing routine returns to a past structure whose stage is the number q of stages before the current stage.

Moreover, when data indicative of a value of the unit deletion probability p for each unit is input to the processing unit 11 from the input unit 10, the processing unit 11 receives the data in step S30.

At that time, the processing unit 11 uses a declared variable r, and expresses an input structure of the target neural network using the variable r as A^{(r)}, and expresses input connection weights between units included in the current structure A^{(r)} is represented using the variable r as W^{(r)}.

The processing unit 11d sets the variable r to an initial value of 0 in step S30a, and changes initial values of the connection weights W^{(r=0)} using random numbers in step S31.

Next, the processing unit 11 performs optimization of the target neural network, i.e. optimization of the number of units in each inter mediate layer thereof in step S32. Specifically, the processing unit 11 sequentially performs the operations in steps S10a to S15 illustrated in FIG. 5 using the input structure A^{(r)} and input connection weights W^{(r)} as the input structure A^{s} and input connection weights W^{s}, thus obtaining the candidate structures At⁰ At⁰, At¹, . . . , At^{k-1}, and corresponding candidate connection weights Wt⁰, Wt¹, . . . , Wt^{k-1} stored in the storage unit 15 via the output unit 14 in step S32.

Then, in step S32, the processing unit 11 assigns the candidate structure At^{k-1} and the output connection weights Wt^{k-1} to the structure A^{(r)}, and the connection weights W^{(r)}, respectively. In step S32, the processing unit 11 also assigns a minimum value E^{k-1} of the cost function of the candidate structure At^{k-1} to a minimum value E^{(r)} of the cost function thereof.

Next, the processing unit 11 determines whether to continue training of the target neural network based on change of the initial values of the connection weights in step S33. The operation in step S33 corresponds to, for example, a ninth step of the present disclosure.

Specifically, the processing unit 11 determines whether the variable r is set to 0 or the minimum value E^{(r)} of the cost function of the structure A^{(r)} is lower than a previous minimum value E^{(r-1)} of the cost function of a previous structure A^{(r-1)} in step S33. The condition of whether the minimum value E^{(r)} of the cost function of the structure A^{(r)} is lower than the previous minimum value E^{(r-1)} of the cost function of the previous structure A^{(r-1)} will be simply expressed as relation E^{(r)}<E^{(r-1)}.

That is, the variable r represents a number of times the optimizing step S32 should be executed while changing the initial values of the connection weights.

In step S33, the deter ruination of whether the variable r is set to 0 shows whether the structure A^{(r)} is obtained without change of the initial values of the connection weights, i.e. the connection weights W^{(r)} are obtained first by the optimizing step S32. Thus, there is no previous minimum value E^{(r-1)} of the cost function of a previous structure A^{(r-1)}.

When the variable r is set to 0 (the determination in step S33 is YES), the optimizing routine proceeds to step S33a. In step S33a, the processing unit 11 increments the variable r by 1, and initializes a declared variable f, thus substituting the upper-limit number F into the variable f. The operation in step S33a corresponds to an eleventh step of the present disclosure. Thereafter, the optimizing routine proceeds to step S35.

In addition, in step S33, the determination of whether the relation E^{(r)}<E^{(r-1)} is satisfied shows whether the minimum value E^{(r)} of the cost function of the structure A^{(r)}, which has been currently obtained by changing the initial values of the connection weights, is lower than the previous minimum value E^{(r-1)} of the cost function of the previous structure A^{(r-1)}.

Upon determination that the relation E^{(r)}<E^{(r-1)} is satisfied (YES in step S33), the processing unit 11 executes the operation in step S33a set forth above. Particularly, the operation in step S33a increments the current value of the variable r by 1, and initializes the variable f to the upper-limit number F.

Thereafter, the optimizing routine proceeds to step S35.

In step S35, the processing unit 14 assigns the past structure A^{ceil(q(s-1))} to the structure A^{(r)}, and changes the initial values of the connection weights of the connection weights W^{(r)} of the structure A^{(r)} using random numbers in step S35.

Note that a function ceil(x) is defined to return nearest integer value that is greater than or equal to an argument x passed to the function ceil(x). That is, value q(k−1) is passed as argument x to the function ceil(x), the function ceil(x) returns nearest integer value that is greater than or equal to the argument q(k−1). For example, if k−1 is set to 6 and q is set to 0.6, the function ceil(6×0.6), i.e. the function ceil(3.6), returns 4. That is, the processing unit 14 assigns the past structure A⁴ at the fourth stage, which is two stages before the current structure At^{k-1}=At⁶, to the structure A^{(r)}.

Otherwise, it is determined that the variable r is unset to 0 and the relation E^{(r)}<E^{(r-1)} is unsatisfied (NO in step S33).

The negative determination in step S33 means that the minimum value E^{(r)} of the cost function of the structure A^{(r)}, which has been currently obtained by changing the initial values of the connection weights W^{(r)}, is equal to or higher than the previous minimum value E^{(r-1)} of the cost function of the previous structure A^{(r-1)}. That is, the processing unit 11 determines that the generalization ability of the previous structure A^{(r-1)} is higher than that of the structure A^{(r)}.

Then, the processing unit 11 decrements the variable f by 1 in step S33b, and determines whether the variable f is zero in step S34. The operation in step S33b corresponds to, for example, a tenth step of the present disclosure.

When it is determined that the variable f is not zero (NO in step S34), the optimizing routine proceeds to step S35. The operation in step S35 corresponds to, for example, an eight step of the present disclosure.

In step S35, as described above, the processing unit 11 assigns the previously obtained structure A^{ceil(q(k-1))} to the structure A^{(r)}, and changes the initial values of the connection weights W^{(r)} using random numbers.

After the operation in step S35, the optimizing routine returns to step S32. Then, the processing unit 11 performs, as described above, optimization of the current connection weights W^{(r)} of the current structure A^{(r)}. This obtains the candidate structure At^{k-1}, the candidate connection weights Wt^{k-1}, and the corresponding minimum value E^{k-1} of the cost function as the structure A^{(r)}, the connection weights W^{(r)}, and the minimum value E^{(r)} of the cost function, respectively.

Specifically, the processing unit 11 repeats a first sequence of the operations in steps S32, S33, S33a, and S35 while incrementing the variable r by 1, and initializing the variable f to the upper-limit number F.

That is, the first sequence represents repetition of execution of the optimizing step S32 while changing the initial values of the connection weights from the specified past stage.

During repetition of the first sequence, at a current value of the variable r, if the determination in step S33 is NO, the processing unit 11 repeats a second sequence of the operations in steps, S34, S35, S32, and S33 while keeping the current value of the variable r not incremented until the determination in step S34 is negative.

During repetition of the second sequence, if the deter ruination in step S33 is affirmative, the processing unit 11 increments the current value of the variable r by 1, and initializes the variable f to the upper-limit number F. Thereafter, the processing unit 11 returns to the first sequence from the operation in step S35.

Otherwise, during repetition of the second sequence, let us consider the determination in step S34 is affirmative. Specifically, let us consider a situation where repeating the second sequence F times does not reduce the respective minimum values E^{(r)} of the cost functions of the structures A^{(r)} as compared with the previous minimum value E^{(r-1)} of the cost function of the previous structure A^{(r-1)}.

In this situation, the processing unit 11 determines termination of the optimizing routine of the target neural network. That is, the variable f and the upper-limit value F therefor serve to determine whether to stop the optimizing of the target neural network. Following the affirmative determination in step S34, the optimizing routine proceeds to step S36.

In step S36, the processing unit 11 outputs the specific structure A^{(r-1)} and the corresponding specific connection weight W^{(r-1)} via the output unit 14 as an optimum structure and optimum connection weights of the target neural network. The operations in steps S34 and S36 correspond to, for example, a twelfth step of the present disclosure.

As described above, the method and system for obtaining an improved structure of a neural network according to the second embodiment are configured to repeat optimization of the connection weights and the number of units of the target neural network described in the first embodiment while changing initial values given to the connection weights. This reduces the dependency of how the target neural network is optimized on initial values of the connection weights, thus further improving the generalization ability of the target neural network.

### Third Embodiment

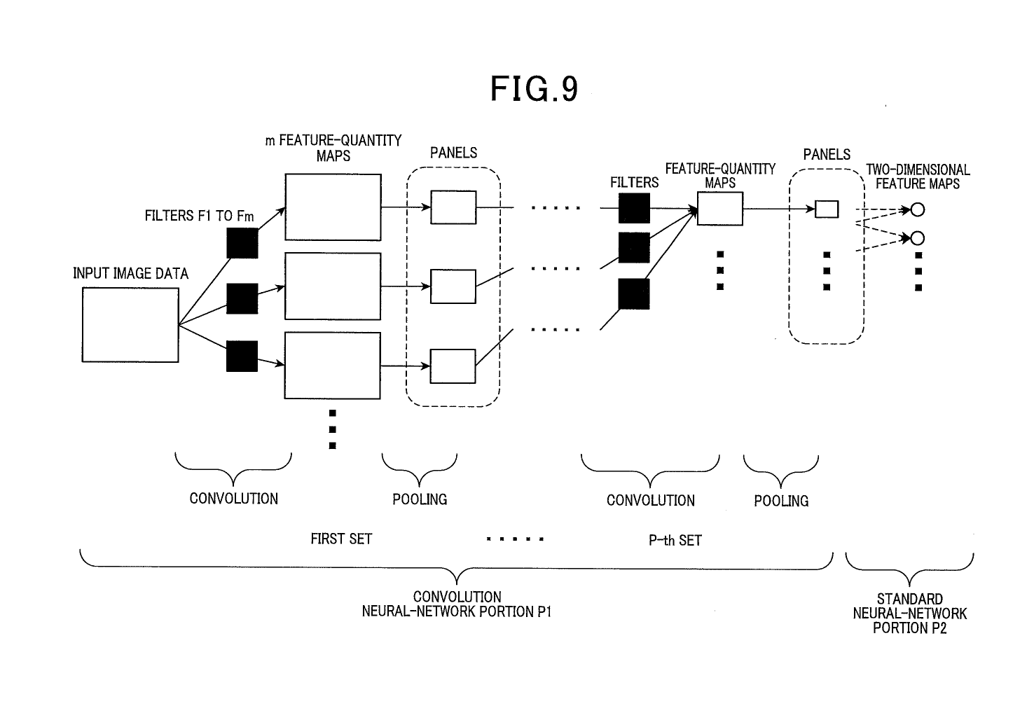

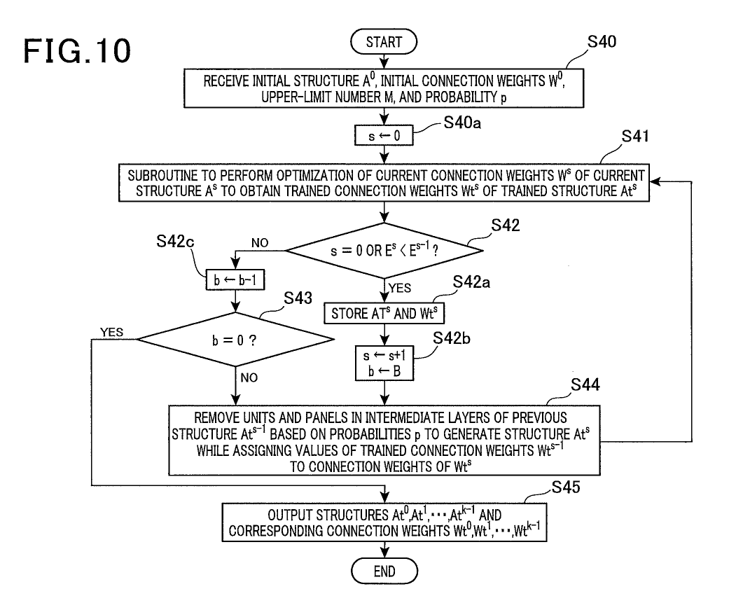

A method and a system for obtaining an improved structure of a target neural network according to a third embodiment of the present disclosure will be described hereinafter with reference to FIGS. 9 and 10. In the third embodiment, the method and system are designed to optimize the structures of convolution neural networks as target neural networks to be optimized.

FIG. 9 schematically illustrates an example of the structure of a target convolution neural network to be optimized. An input to the convolution neural network is an image comprised of the two-dimensional array of pixels. Like the first embodiment, a first training-data set and a second training-data set are used in the neural network optimizing method according to the third embodiment.

The first training-data set is used to update connection weights between units of different layers of the convolution neural network to thereby obtain an updated structure of the target convolution neural network. The second training-data set, which is completely separate from the first training-data set, is used to calculate costs of respective updated structures of a target convolution neural network for evaluating the updated structures of the target convolution neural network without being used for the update of the connection weights.

Each of the first and second training-data set includes training data. The training data is comprised of: pieces of input image data each designed as a multidimensional vector or a scalar; and pieces of output image data, i.e. supervised image data, designed as a multidimensional vector or scalar; the pieces of input image data respectively correspond to the pieces of output image data. That is, the training data is comprised of many pairs of input image data and output image data.

As illustrated in FIG. 9, the target convolution neural network includes a convolution neural-network portion P1 and a standard neural-network portion P2.

The convolution neural-network portion P1 is comprised of a convolution layer including a plurality of filters, i.e. convolution filters, F1, . . . , Fm to which input image data is input. Each of the filters F1 to Fm has a local two-dimensional array of n×n pixels; the size of each filter corresponds to a part of the size of the input image data. Elements of each of the filters F1 to Fm, such as pixel values thereof, serve as connection weights as described in the first embodiment. For example, the connection weights of each filter respectively have same values. A bias can be added to each of the connection weights of each filter. Known convolution operations are carried out between the input image data and each of the filters F1 to Fm, so that m feature-quantity images, i.e. maps, are generated.

The convolution neural-network portion P1 is also comprised of a pooling layer, i.e. a sub-sampling layer. In the pooling layer, sub-sampling, i.e. pooling, is applied to each of the m feature-quantity images sent from the convolution layer. The pooling reduces in size each of the m feature-quantity maps in the following method. The method divides each of the m feature-quantity maps into 2×2 pixel tiles, and calculates an average value of the pixel values of the respective four pixels of each tile. This reduces in size each of the m feature-quantity maps as one quarter of each of the m feature-quantity maps.

Next, the pooling performs non-linear transformation of each element, i.e. each pixel value, of each of the downsized m feature-quantity maps using an activation function, such as a sigmoid function. The pooling makes it possible to reduce in size each of the m feature-quantity maps without loss the positional features of a corresponding one of the m feature-quantity maps.

The non-linear transformation of each element of each of the downsized m feature-quantity maps generates two-dimensional feature maps, referred to as panels.

The convolution neural-network portion P1 is configured as a multilayer structure composed of plural sets, i.e. p sets, of the convolution layer and the pooling layer. That is, the convolution neural-network portion P1 repeats, at p times, the set of the convolution using convolution filters and the pooling, thus obtaining two-dimensional feature maps, i.e. panels. That is, the convolution neural-network portion P1 is configured to sequentially perform the first set of the convolution and the pooling, the second set of the convolution and the pooling, . . . , and the p-th set of the convolution and the pooling.

The standard neural-network portion P2 is designed, as a target neural network described in the first embodiment, to perform recognition of input image data to the target neural network. Specifically, the standard neural-network portion P2 is comprised of an input layer, one or more intermediate layers, and an output layer (see FIG. 3A as an example). Specifically, the panels generated based on the p-th set of the convolution and the pooling serve as input data to the input layer of the standard neural-network portion P2.

A collection of panels obtained by the pooling in each set of the convolution and the pooling will be referred to as an intermediate layer, i.e. a hidden layer. That is, the number of panels in each inter mediate layer corresponds to the number of filters located prior to the corresponding intermediate layer.

In other words, assuming that the input image data serves as an input layer, the target convolution neural network includes connection weights of filters between different layers of the convolution neural-network portion P1. Thus, the method and system according to the third embodiment makes it possible to handle the connection weights of the filters as those between different layers of a target neural network according to the first embodiment.

Next, the method and system for obtaining an improved structure of a target neural network according to the third embodiment of the present disclosure will be described hereinafter. The method and the system according to the third embodiment are configured to be substantially identical to those according to the first embodiment except that the target neural network is a convolution neural network illustrated in FIG. 9.

FIG. 10 schematically illustrates an example of specific steps of an optimizing routine, which is carried out by the processing unit 11, corresponding to the method according to the third embodiment.

As described above, the target convolution neural network is comprised of the convolution neural-network portion P1 and the standard neural-network portion P2. The connection weights of the filters included in the convolution-neural network portion P1 can serve as those between different layers of a target neural network according to the first embodiment. In addition, the standard neural-network portion P2 is designed to be identical to a target neural network according to the first embodiment.

Thus, it is possible to apply the optimizing routine illustrated in FIG. 5 to each of the convolution neural-network portion P1 and the standard neural-network portion P2 in order to optimize the structure of a corresponding one of the convolution-neural network portion P1 and the standard neural-network portion P2.

Specifically, the processing unit 11 according to the third embodiment is configured to perform the operations in steps S40 to S45 illustrated in FIG. 10, which are substantially identical to the operations in steps S10 to S15 illustrated in FIG. 5 for each of the convolution neural-network portion P1 and the standard neural-network portion P2 substantially at the same time.

Particularly, in step S44, the processing unit 11 is configured to:

remove panels in one or more intermediate layers, i.e. hidden layers, of the previous trained structure At^{s-1} of the convolution neural-network portion P1 based on the values of the unit deletion probability p for all the respective panels included in the previous trained structure At^{s-1}, thus generating a structure A^{s} of the convolution neural-network portion P1; and

remove units in one or more intermediate layers, i.e. hidden layers, of the previous trained structure At^{s-1} of the standard neural-network portion P2 based on the values of the unit deletion probability p for all the respective units included in the previous trained structure At^{s-1}, thus generating a structure A^{s} of the standard neural-network portion P2.

This obtains:

the candidate structures At⁰ At⁰, At¹, . . . , At^{k-1} of the convolution neural-network portion P1, and corresponding candidate connection weights Wt⁰, Wt¹, . . . , Wt^{k-1} thereof; and

the candidate structures At⁰ At⁰, At¹, . . . , At^{k-1} of the standard neural-network portion P2, and corresponding candidate connection weights Wt⁰, Wt¹, . . . , Wt^{k-1} thereof.

This makes it possible to optimize the connection weights of each filter of the convolution neural-network portion P1, thus extracting feature-quantity images that can be efficiently used to recognize input image data.

As described above, the method and system according to the third embodiment make it possible to automatically determine the number of panels in one or more intermediate layers of the convolution neural-network portion P1 of the target convolution neural network while preventing redundant training after the occurrence of overtraining. In contrast, there have been proposed no conventional methods for automatically determining the structure of a convolution neural network in view of improvement of the generalization ability of the convolution neural network.

Thus, in addition to the effects achieved by the method and system 1 according to the first embodiment, it is possible to automatically determine an optimum structure of a target convolution neural network that has improved its generalization ability while reducing an amount of calculation required to perform the training of the target convolution neural network.

In addition, the method and system according to the third embodiment are configured to:

remove panels in one or more intermediate layers of the previous trained structure At^{s-1} of the convolution neural-network portion P1; and

simultaneously, remove units in one or more intermediate layers of the previous trained structure At^{s-1} of the standard neural-network portion P2.

This results in reduction of redundant obtaining of feature-quantity images that correlate with some units and/or panels that have been removed from the target convolution neural network.

### Fourth Embodiment

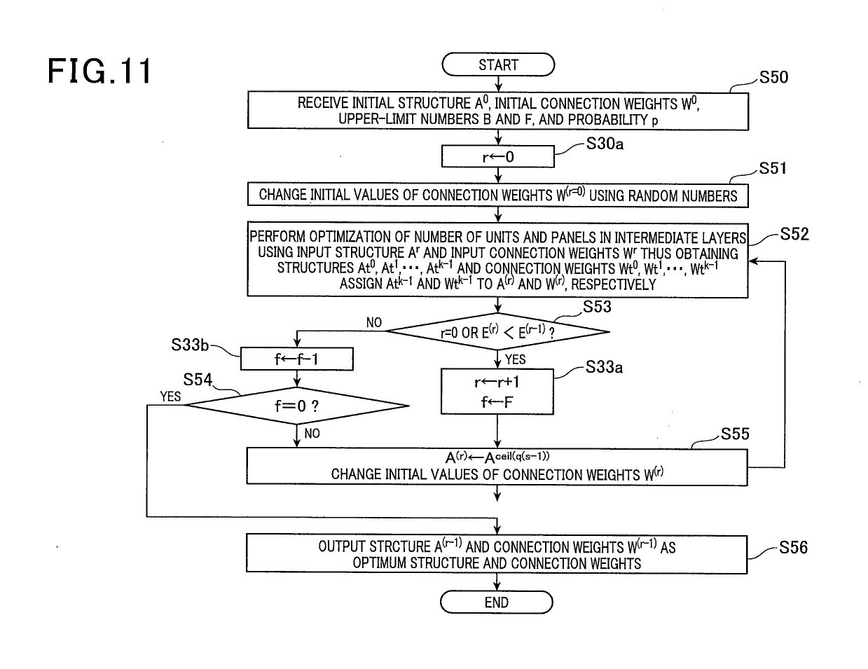

A method and a system for obtaining an improved structure of a target neural network according to a fourth embodiment of the present disclosure will be described hereinafter with reference to FIG. 11. In the fourth embodiment, the method and system are designed to optimize the structure of a target convolution neural network, which has been described in the third embodiment, in the same manner as those according to the second embodiment except that the target neural network is the convolution neural network illustrated in FIG. 9.

FIG. 11 schematically illustrates an example of specific steps of an optimizing routine, which is carried out by the processing unit 11, corresponding to the method according to the fourth embodiment.

As described above, the target convolution neural network is comprised of the convolution neural-network portion P1, and the standard neural-network portion P2. The connection weights of the filters included in the convolution-neural network portion P1 can serve as those between different layers of a target neural network according to the second embodiment. In addition, the structure of the standard neural-network portion P2 is designed to be identical to that of a target neural network according to the second embodiment.

Thus, it is possible to apply the optimizing routine illustrated in FIG. 8 to each of the convolution neural-network portion P1 and the standard neural-network portion P2 in order to optimize the structure of a corresponding one of the convolution-neural network portion P1 and the standard neural-network portion P2.

Specifically, the processing unit 11 according to the fourth embodiment is configured to perform the operations in steps S50 to S56 illustrated in FIG. 11, which are substantially identical to the operations in steps S30 to S36 illustrated in FIG. 8 for each of the convolution neural-network portion P1 and the standard neural-network portion P2 substantially at the same time.

Particularly, in step S52, the processing unit 11 is configured to perform:

optimization of the number of panels in each intermediate layer of the convolution neural-network portion P1 to thereby optimize the structure thereof; and

optimization of the number of units in each intermediate layer of the standard neural-network portion P2 to thereby optimize the structure thereof.

Specifically, the processing unit 11 sequentially performs the operations in steps S40a to S45 illustrated in FIG. 10 using the input structure A^{(r)} and input connection weights W^{(r)} as the input structure A^{s} and input connection weights W^{s}.

This obtains:

the candidate structures At⁰ At⁰, A₁, . . . , At^{k-1} of the convolution neural-network portion P1, and corresponding candidate connection weights Wt⁰, Wt¹, . . . , Wt^{k-1} thereof; and

the candidate structures At⁰ At⁰, At¹, . . . , At^{k-1} of the standard neural-network portion P2, and corresponding candidate connection weights Wt⁰, Wt¹, . . . , Wt^{k-1} thereof.

As described above, the method and system according to the fourth embodiment make it possible to automatically determine the number of panels in each intermediate layer of the convolution neural-network portion P1 of the target convolution neural network while preventing redundant training after the occurrence of overtraining. In contrast, there have been proposed no conventional methods for automatically determining the structure of a convolution neural network in view of improvement of the generalization ability of the convolution neural network.

Thus, in addition to the effects achieved by the method and system according to the second embodiment, it is possible to automatically determine an optimum structure of a target convolution neural network that has improved its generalization ability while reducing an amount of calculation required to pedal in the training of the target convolution neural network.

The methods and systems according to the first to fourth embodiments of the present disclosure have been described, but methods and systems according to the present disclosure are not limited to those according to the first to fourth embodiments.

The method and system according to each of the first to fourth embodiments are configured to remove units in at least one intermediate layer between an input layer and an output layer of a target neural network, but can remove units in the input layer of the target neural network. Removal of units in the input layer makes it possible to, if pieces of input data to the target neural network include pieces of redundant input data, extract pieces of input data that are required to be used by the target neural network. Specifically, if pieces of data are included in pieces of input data to the target neural network, removal of units in the input layer in addition to at least one intermediate layer results in further optimization of the structure of the target neural network.

The method and system according to each of the third and fourth embodiments of the present disclosure are configured to remove panels in at least one intermediate layer of the convolution neural-network portion P1. However, the present disclosure is not limited to this configuration. Specifically, the method and system according to each of the third and fourth embodiments of the present disclosure can be configured to eliminate filters of the convolution neural-network pattern P1 in place of or in addition to panels thereof. If a target convolution neural network includes multiple convolution layers, i.e. plural sets of the convolution layer and the pooling layer, as illustrated in FIG. 9, removal of a panel in a pooling layer of the convolution neural-network pattern P1 leads to a different result as compared to a result obtained based on removal of a filter in a convolution layer thereof. Specifically, elimination of a panel in a pooling layer of the convolution neural-network pattern P1 results in elimination of filters connected to the eliminated panel.

In contrast, elimination of a filter in a convolution layer does not result in elimination of panels connected to the eliminated filter, so that elimination of all filters connected to a panel results in elimination of the panel. That is, the first configuration of eliminating filters of the convolution neural-network pattern P1 makes it harder to eliminate panels together with the eliminated filters, resulting in further increase of an amount of calculation required to perform the training of the target convolution neural network in comparison to the second configuration of eliminating panels of the convolution neural-network pattern P1. However, the first configuration of eliminating filters increases the independence of each panel, thus further improving the generalization ability of the target convolution neural network having the first configuration in comparison to that of the target convolution neural network having the second configuration.

Next, the results of an experiment using the method according to, for example, the second embodiment will be described hereinafter.

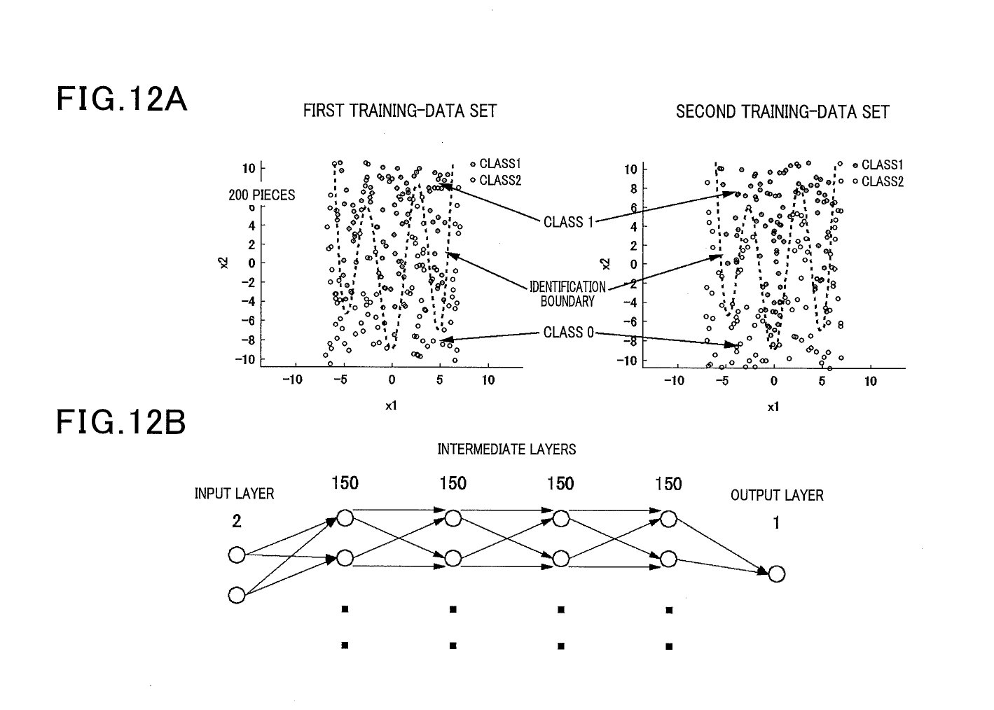

FIG. 12A schematically illustrates the first training-data set and the second training-data set used in the experiment. As the first training-data set, 100 pieces of data categorized in a class 1 and 100 pieces of data categorized in a class 2 were prepared. As the second training-data set, 100 pieces of data categorized in the class 1 and 100 pieces of data categorized in the class 2 were similarly prepared. 100 pieces of data categorized in the class 1 for the first training-data set are respectively different from those of data categorized in the class 1 for the second training-data set. Similarly, 100 pieces of data categorized in the class 2 for the first training-data set are respectively different from those of data categorized in the class 2 for the second training-data set. Note that the first class and the second class defined in a data space are separate from each other by an identification boundary in the data space.

FIG. 12B illustrates an initial structure of a target neural network given to the method in the experiment. As illustrated in FIG. 12B, the initial structure of the target neural network is comprised of the input layer, the first to fourth intermediate (hidden) layers, and the output layer. The input layer includes two units, each of the first to fourth intermediate layers includes 150 units, and the output layer includes a single unit.

That is the initial structure of the target neural network illustrated in FIG. 12A will be referred to as a 2-15-15-15-15-1 structure.

That is, two variables, i.e. two units of the input layer, corresponding to the class 1 and class 2 were used, and a single output variable corresponding to the single unit in the output layer were used.

As the experiment, the method according to the second embodiment was carried out to optimize the target neural network with the initial structure illustrated in FIG. 12B using the first training-data set and the second training-data illustrated in FIG. 12A.

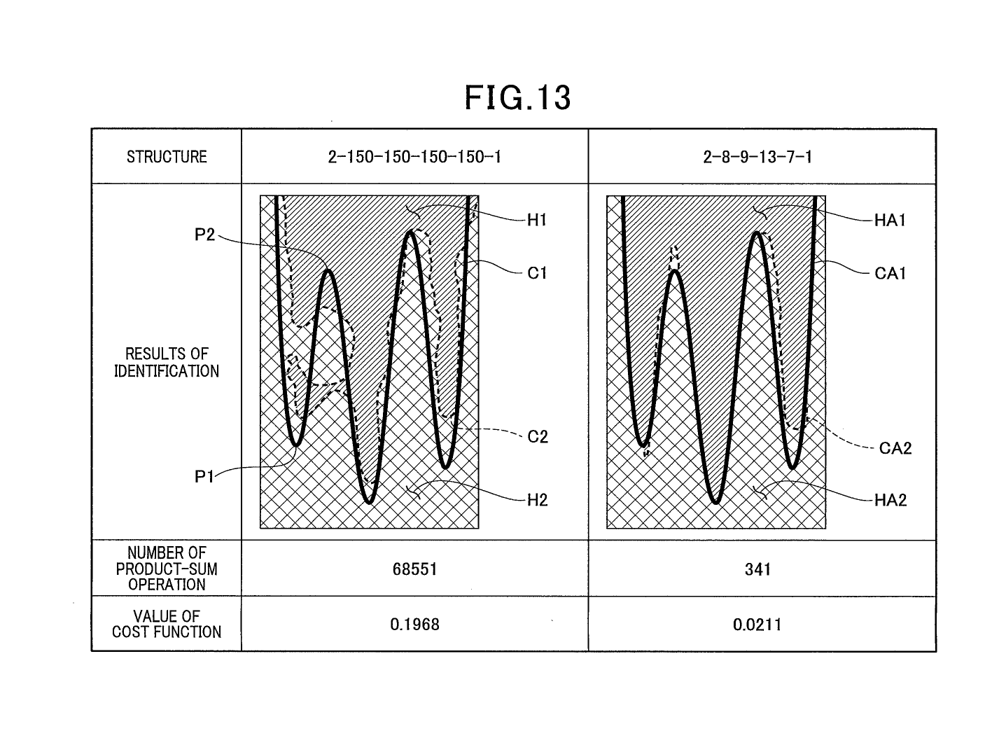

FIG. 13 demonstrates the results of the experiment.

The left column in FIG. 13 represents results of identification of many pieces of data by the 2-15-15-15-15-1 structure of the target neural network whose connection weights have been trained (see label “RESULTS OF IDENTIFICATION”). The 2-15-15-15-15-1 structure of the target neural network whose connection weights have been trained will be referred to as a trained 2-15-15-15-15-1 structure of the target neural network.

In the graph included in the left column in FIG. 13, the horizontal axis represents a coordinate of each of the two input variables, and the vertical axis represents a coordinate of the output variable.

In the graph, a solid curve C1 represents a true identification function, i.e. a true identification boundary, between the class 1 and class 2. A first hatched region H1 represents data identified by the trained 2-15-15-15-15-1 structure of the target neural network as data included in the class 2, and a second hatched region H2 represents data identified by the trained 2-15-15-15-15-1 structure of the target neural network as data included in the class 1. A dashed curve C2 represents an obtained identification function, i.e. an identification boundary, implemented by the trained 2-15-15-15-15-1 structure of the target neural network, i.e. the identification boundary between the first and second hatched regions H1 and H2.

That is, the closer the dashed curve C2 is to the solid curve C1, the more the target neural network is optimized.

The left column in FIG. 13 also represents the number of product-sum operations (see label “NUMBER OF PRODUCT-SUM OPERATIONS”) required to calculate the operations, expressed as:

$${\sum }_{i = 0}^{k} {X}_{i} {W}_{i} ,$$

in all the units except for the input units of the trained 2-15-15-15-15-1 structure of the target neural network. That is, when the operations, expressed as:

$${\sum }_{i = 0}^{k} {X}_{i} {W}_{i} ,$$

are developed for all the units except for the input units, the number of terms for all the units except for the input units are added to each other to obtain the number of product-sum operations.

The left column in FIG. 13 further represents a value of the cost function of the trained 2-15-15-15-15-1 structure of the target neural network (see label “VALUE OF COST FUNCTION”).

The label “RESULTS OF IDENTIFICATION” in the left column shows that some pieces of data, which are located close to troughs of the identification function of the trained 2-15-15-15-15-1 structure of the target neural network, cannot be identified by the trained 2-15-15-15-15-1 structure thereof.

The label “NUMBER OF PRODUCT-SUM OPERATIONS” in the left column shows 68,551 as the number of product-sum operations of all the units except for the input units in the trained 2-15-15-15-15-1 structure of the target neural network.

The label “VALUE OF COST FUNCTION”) in the left column shows 0.1968 as the value of the cost function of the trained 2-15-15-15-15-1 structure of the target neural network.

In contrast, the right column in FIG. 13 represents an optimized structure of the target neural network achieved by the experiment. The optimized structure of the target neural network is a 2-8-9-13-7-1 structure thereof (see label “RESULTS OF IDENTIFICATION”).

The right column in FIG. 13 represents results of identification of many pieces of data by the 2-8-9-13-7-1 structure of the target neural network.

In the graph included in the right column in FIG. 13, the horizontal axis represents a coordinate of each of the two input variables, and the vertical axis represents a coordinate of the output variable.

In the graph, a solid curve CA1 represents a true identification function, i.e. a true identification boundary, between the class 1 and class 2. A first hatched region HA1 represents data identified by the 2-8-9-13-7-1 structure of the target neural network as data included in the class 2, and a second hatched region HA2 represents data identified by the trained 2-8-9-13-7-1 structure of the target neural network as data included in the class 1. A dashed curve CA2 represents an obtained identification function, i.e. an identification boundary, implemented by the 2-8-9-13-7-1 structure of the target neural network, i.e. the identification boundary between the first and second hatched regions H1 and H2.

As easily understood by comparison between the relationship of the solid and dashed curves C1 and C2 and the relationship of the solid and dashed curves CA1 and CA2, the dashed curve CA2 closely matches with the true identification function, i.e. the identification boundary CA1. In contrast, the relationship of the solid and dashed curves C1 and C2 demonstrates that some pieces of data, which are close to local peaks P1 and P2, are erroneously identified.

That is, the 2-8-9-13-7-1 structure of the target neural network. achieved by the method according to the second embodiment has a higher identification ability as compared with that achieved by the trained 2-15-15-15-15-1 structure of the target neural network.

In addition, the label “NUMBER OF PRODUCT-SUM OPERATIONS” in the right column shows 341 as the number of product-sum operations of all the units in the 2-8-9-13-7-1 structure of the target neural network. That is, the method according to the second embodiment results in wide reduction of the number of product-sum operations required for the 2-8-9-13-7-1 structure of the target neural network as compared with that required for the trained 2-15-15-15-15-1 structure of the target neural network.

Moreover, the label “VALUE OF COST FUNCTION”) in the right column shows 0.0211 as the value of the cost function of the 2-8-9-13-7-1 structure of the target neural network. That is, the method according to the second embodiment results in significant reduction of the value of the cost function of the 2-8-9-13-7-1 structure as compared with that of the cost function of the trained 2-15-15-15-15-1 structure of the target neural network.

Accordingly, the methods and systems according to the present disclosure are capable of providing neural networks each having a simple and optimum structure and higher generalization ability. Thus, they can be effectively applied for various purposes, such as image recognition, character recognition, prediction of time-series data, and the other technical approaches.

The present disclosure can include the following fourth to sixth aspects thereof as modifications as the respective first to third aspects:

According to the fourth exemplary aspect, there is provided a method of obtaining an improved structure of a target neural network.

The method includes a first step (for example, steps S10 and S11) of:

performing training of connection weights between a plurality of units included in an input structure of a target neural network using a first training-data set to thereby train the input structure of the target neural network; and

calculating a value of a cost function of a trained structure of the target neural network using a second training-data set separate from the first training-data set.

The training is continued until the calculated value of the cost function of a trained structure of the target neural network becomes a minimum value, the trained structure of the target neural network when the training is stopped being referred to as a candidate structure of the target neural network.

The method includes a second step (for example, see step S14) of randomly removing at least one unit from the candidate structure of the target neural network to give a generated structure of the target neural network based on the random removal to the first step as the input structure of the target neural network, thus executing plural sequences of the first and second steps.

The method includes a third step (for example, see step S12) of determining, for each of the sequences, whether the minimum value of the cost function of the candidate structure obtained by the first step of the sequence is lower than that of the cost function of the candidate structure obtained by the first step of a sequence immediately previous to the sequence.

When it is determined that the minimum value of the cost function of the candidate structure obtained by the first step of a k-th sequence (k is an integer equal to or greater than 2) is lower than the minimum value of the cost function of the candidate structure obtained by the first step of a previous (k−1)-th sequence (for example, see YES in step S12), the method includes a fourth step (for example, see step S14) of performing the second step of the k-th sequence using the candidate structure obtained by the first step of the (k−1)-th sequence.

When it is determined as a trigger deter ruination that the minimum value of the cost function of the candidate structure obtained by the first step of a k-th sequence is equal to or higher than the minimum value of the cost function of the candidate structure obtained by the first step of a (k−1)-th sequence (for example, see NO in step S12), the method includes a fifth step (for example, see steps S12c and S14) of performing, as the second step of the k-th sequence, a step of randomly removing at least one unit from the candidate structure obtained by the first step of the (k−1)-th sequence again, thus giving a new generated structure of the target neural network to the first step as the input structure of the target neural network, and performing (for example, see returning to step S11) the k-th sequence again using the new generated structure of the target neural network.

According to the fifth exemplary aspect, there is provided a system for obtaining an improved structure of a target neural network. The system includes a storage unit that stores therein a first training-data set and a second training-data set for training the target neural network, the second training-data set being separate from the first training-data set, and a processing unit.

The processing unit includes a training module. The training module performs a training process (for example, see steps S10 and S11) of:

training connection weights between a plurality of units included in an input structure of the target neural network using the first training-data set to thereby train the input structure of the target neural network; and

calculating a value of a cost function of a trained structure of the target neural network obtained for the training process using the second training-data set.

The training process is continued until the calculated value of the cost function of a trained structure of the target neural network becomes a minimum value. The trained structure of the target neural network when the training process is stopped is referred to as a candidate structure of the target neural network. The processing unit includes a removing module that:

performs a random removal process (for example, see step S14) of randomly removing at least one unit from the candidate structure of the target neural network trained by the training unit to give a generated structure of the target neural network based on the random removal to the training unit as the input structure of the target neural network, thus executing plural sequences of the training process and removing process; and

determines (for example, see step S12), for each of the sequences, whether the minimum value of the cost function of the candidate structure obtained by the training process of the sequence is lower than the minimum value of the cost function of the candidate structure obtained by the training process of a sequence immediately previous to the sequence.

When it is determined that the minimum value of the cost function of the candidate structure obtained by the training process of a k-th sequence (k is an integer equal to or greater than 2) is lower than the minimum value of the cost function of the candidate structure obtained by the training process of a (k−1)-th sequence (for example, see YES in step S12), the removing module performs the random removal process (for example, see step S14) of the k-th sequence using the candidate structure obtained by the training process of the (k−1)-th sequence.

When it is determined as a trigger determination that the minimum value of the cost function of the candidate structure obtained by the training process of a k-th sequence is equal to or higher than the minimum value of the cost function of the candidate structure obtained by the training step of a (k−1)-th sequence (for example, see NO in step S12), the removing module:

performs (for example, see steps S12c and S14), as the removal process of the k-th sequence, a random removal (for example, see steps S12c and S14) of at least one unit from the candidate structure obtained by the training process of the (k−1)-th sequence again, thus giving a new generated structure of the target neural network to the training process as the input structure of the target neural network; and

performs (for example, see returning to step S11) the k-th sequence again using the new generated structure of the target neural network.

According to the sixth exemplary aspect, there is provided a program product usable for a system for obtaining an improved structure of a target neural network. The program product includes a non-transitory computer-readable medium; and a set of computer program instructions embedded in the computer-readable medium. The instructions cause a computer to:

perform a training process (for example, steps S10 and S11) of:

training connection weights between a plurality of units included in an input structure of the target neural network using the first training-data set to thereby train the input structure of the target neural network; and

calculating a value of a cost function of a trained structure of the target neural network obtained for the training process using the second training-data set.

The training process is continued until the calculated value of the cost function of a trained structure of the target neural network becomes a minimum value, the trained structure of the target neural network when the training process is stopped being referred to as a candidate structure of the target neural network.

The instructions cause a computer to:

performs a random removal process (for example, see step S14) of randomly removing at least one unit from the candidate structure of the target neural network trained by the training unit, thus giving a generated structure of the target neural network based on the random removal to the training unit as the input structure of the target neural network, thus executing plural sequences of the training process and removing process; and

determines (for example, see step S12), for each of the sequences, whether the minimum value of the cost function of the candidate structure obtained by the training process of the sequence is lower than the minimum value of the cost function of the candidate structure obtained by the training process of a sequence immediately previous to the sequence.

When it is determined that the minimum value of the cost function of the candidate structure obtained by the training process of a k-th sequence (k is an integer equal to or greater than 2) is lower than the minimum value of the cost function of the candidate structure obtained by the training process of a (k−1)-th sequence (for example, see YES in step S12), the instructions cause a computer to perform the random removal process of the k-th sequence using the candidate structure obtained by the training process of the (k−1)-th sequence.

When it is determined as a trigger determination that the minimum value of the cost function of the candidate structure obtained by the training process of a k-th sequence is equal to or higher than the minimum value of the cost function of the candidate structure obtained by the training step of a (k−1)-th sequence (for example, see NO in step S12), the instructions cause a computer to:

perform (for example, see steps S12c and S14), as the removal process of the k-th sequence, a random removal of at least one unit from the candidate structure obtained by the training process of the (k−1)-th sequence again, thus giving a new generated structure of the target neural network to the training process as the input structure of the target neural network; and

perform (for example, see returning to step S11) the k-th sequence again using the new generated structure of the target neural network.

While illustrative embodiments of the present disclosure have been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A method of obtaining an improved structure of a target neural network, the method comprising:
a first step of:
performing training of connection weights between a plurality of units included in an input structure of a target neural network using a first training-data set to thereby train the input structure of the target neural network; and
calculating a value of a cost function of a trained structure of the target neural network using a second training-data set separate from the first training-data set,
the training being continued until the calculated value of the cost function of a trained structure of the target neural network becomes a minimum value, the trained structure of the target neural network when the training is stopped being referred to as a candidate structure of the target neural network;
a second step of randomly removing at least one unit from the candidate structure of the target neural network to give a generated structure of the target neural network based on the random removal to the first step as the input structure of the target neural network, thus executing plural sequences of the first and second steps;
a third step of determining, for each of the sequences, whether the minimum value of the cost function of the candidate structure obtained by the first step of the sequence is lower than that of the cost function of the candidate structure obtained by the first step of a sequence immediately previous to the sequence;
when it is determined that the minimum value of the cost function of the candidate structure obtained by the first step of a specified-number sequence is lower than the minimum value of the cost function of the candidate structure obtained by the first step of a previous sequence immediately previous to the specified-number sequence,
a fourth step of performing the second step of the specified-number sequence using the candidate structure obtained by the first step of the previous sequence; and
when it is determined as a trigger determination that the minimum value of the cost function of the candidate structure obtained by the first step of a specified-number sequence is equal to or higher than the minimum value of the cost function of the candidate structure obtained by the first step of a previous sequence immediately previous to the specified-number sequence,
a fifth step of performing, as the second step of the specified-number sequence, a step of randomly removing at least one unit from the candidate structure obtained by the first step of the previous sequence again, thus giving a new generated structure of the target neural network to the first step as the input structure of the target neural network, and performing the specified-number sequence again using the new generated structure of the target neural network.

2. The method according to claim 1, further comprising:
a sixth step of determining whether the trigger determination was continuously carried out at preset times so that the specified-number sequence was performed at the preset times during execution of the plural sequences; and
a seventh step of determining the candidate structure of the target neural network obtained by the first step of the previous sequence as an optimum structure thereof when it is determined the trigger determination was successively carried out at the preset times so that the specified-number sequence was performed at the preset times.

3. The method according to claim 2, wherein the connection weights between the units have initial values, the method further comprising:
an eighth step of selecting one of the candidate structures of the target neural network obtained by the respective sequences before execution of the seventh step, and repeatedly executing a sequence of the first to seventh steps using the candidate structure selected in the eighth step as the input structure while changing the initial values to other values;
a ninth step of deter mining, for each of the repeated sequences, whether a minimum value of the cost function of the candidate structure obtained by the seventh step in the sequence is lower than the minimum value of the cost function of the candidate structure obtained by the seventh step in a previous sequence with respect to the sequence;
when it is determined as a second trigger determination that the minimum value of the cost function of the candidate structure obtained by the seventh step in a given-number sequence is equal to or higher than the minimum value of the cost function of the candidate structure obtained by the seventh step in a previous sequence immediately previous to the given-number sequence,
a tenth step of reducing predetermined second preset times;
an eleventh step of resetting the predetermined second preset times to an upper limit when it is determined that the minimum value of the cost function of the candidate structure obtained by the seventh step in a given-number sequence is lower than the minimum value of the cost function of the candidate structure obtained by the seventh step in a previous sequence with respect to the given-number sequence; and
a twelfth step of, when the second trigger determination was successively repeated at the second preset times during the repeated sequences, determining the candidate structure obtained by the seventh step in the previous sequence as a new optimum structure of the target neural network.

4. The method according to claim 1, wherein a predetermined probability is set for each unit of the target neural network, and the second step randomly removes at least one unit from the candidate structure of the target neural network based on the probabilities of units included in the candidate structure.

5. The method according to claim 1, wherein the second step simultaneously removes units from the candidate structure of the target neural network.

6. The method according to claim 1, wherein:
the target neural network includes a convolution neural-network portion and a standard neural-network portion,
the convolution neural-network portion is comprised of a convolution layer including a plurality of convolution filters, and a sub-sampling layer for sub-sampling outputs of the convolution filters to generate a plurality of first units as a part of the units of the target neural network,
the standard neural-network portion includes a plurality of second units as a part of the units of the target neural network,
the convolution filters serve as the connection weights of the first units,
the first step performs training of the connection weights including the convolution filters included in the input structure of the target neural network using the first training-data set to thereby train the input structure of the target neural network, and
the second step randomly removes at least one of a first unit and a second unit from the candidate structure of the target neural network.

7. A system for obtaining an improved structure of a target neural network, the system comprising:
a storage unit that stores therein a first training-data set and a second training-data set for training the target neural network, the second training-data set being separate from the first training-data set; and
a processing unit comprising:
a training module that:
performs a training process of:
training connection weights between a plurality of units included in an input structure of the target neural network using the first training-data set to thereby train the input structure of the target neural network; and
calculating a value of a cost function of a trained structure of the target neural network obtained for the training process using the second training-data set,
the training process being continued until the calculated value of the cost function of a trained structure of the target neural network becomes a minimum value, the trained structure of the target neural network when the training process is stopped being referred to as a candidate structure of the target neural network; and
a removing module that:
performs a random removal process of randomly removing at least one unit from the candidate structure of the target neural network trained by the training unit to give a generated structure of the target neural network based on the random removal to the training unit as the input structure of the target neural network, thus executing plural sequences of the training process and removing process;
determines, for each of the sequences, whether the minimum value of the cost function of the candidate structure obtained by the training process of the sequence is lower than the minimum value of the cost function of the candidate structure obtained by the training process of a sequence immediately previous to the sequence;
when it is determined that the minimum value of the cost function of the candidate structure obtained by the training process of a specified-number sequence is lower than the minimum value of the cost function of the candidate structure obtained by the training process of a previous sequence immediately previous to the specified-number sequence, performs the random removal process of the specified-number sequence using the candidate structure obtained by the training process of the previous sequence; and
when it is determined as a trigger determination that the minimum value of the cost function of the candidate structure obtained by the training process of a specified-number sequence is equal to or higher than the minimum value of the cost function of the candidate structure obtained by the training step of a previous sequence immediately previous to the specified-number sequence, performs, as the removal process of the specified-number sequence, a random removal of at least one unit from the candidate structure obtained by the training process of the previous sequence again, thus giving a new generated structure of the target neural network to the training process as the input structure of the target neural network, and performing the specified-number sequence again using the new generated structure of the target neural network.

8. The system according to claim 7, wherein:
the removing module is configured to:
determine whether the trigger determination was continuously carried at preset times so that the specified-number sequence was performed at the preset times during execution of the plural sequences; and
determine the candidate structure of the target neural network obtained by the training process of the previous sequence as an optimum structure thereof when it is determined the cost minimization determination was successively carried out at the preset times so that the specified-number sequence was performed at the preset times.

9. A program product usable for a system for obtaining an improved structure of a target neural network, the program product comprising:
a non-transitory computer-readable medium; and
a set of computer program instructions embedded in the computer-readable medium, the instructions causing a computer to:
perforin a training process of:
training connection weights between a plurality of units included in an input structure of the target neural network using the first training-data set to thereby train the input structure of the target neural network; and
calculating a value of a cost function of a trained structure of the target neural network obtained for the training process using the second training-data set,
the training process being continued until the calculated value of the cost function of a trained structure of the target neural network becomes a minimum value, the trained structure of the target neural network when the training process is stopped being referred to as a candidate structure of the target neural network;
performs a random removal process of randomly removing at least one unit from the candidate structure of the target neural network trained by the training unit, thus giving a generated structure of the target neural network based on the random removal to the training unit as the input structure of the target neural network, thus executing plural sequences of the training process and removing process;
determines, for each of the sequences, whether the minimum value of the cost function of the candidate structure obtained by the training process of the sequence is lower than the minimum value of the cost function of the candidate structure obtained by the training process of a sequence immediately previous to the sequence; and
when it is determined that the minimum value of the cost function of the candidate structure obtained by the training process of a specified-number sequence is lower than the minimum value of the cost function of the candidate structure obtained by the training process of a previous sequence immediately previous to the specified-number sequence, performs the random removal process of the specified-number sequence using the candidate structure obtained by the training process of the previous sequence; and
when it is determined as a trigger determination that the minimum value of the cost function of the candidate structure obtained by the training process of a specified-number sequence is equal to or higher than the minimum value of the cost function of the candidate structure obtained by the training step of a previous sequence immediately previous to the specified-number sequence, performs, as the removal process of the specified-number sequence, a random removal of at least one unit from the candidate structure obtained by the training process of the previous sequence again, thus giving a new generated structure of the target neural network to the training process as the input structure of the target neural network, and performing the specified-number sequence again using the new generated structure of the target neural network.

10. The program product according to claim 9, wherein:
the instructions further cause a computer to:
determine whether the cost minimization deter urination was continuously carried at preset times so that the specified-number sequence was performed at the preset times during execution of the plural sequences; and
determine the candidate structure of the target neural network obtained by the training process of the previous sequence as an optimum structure thereof when it is determined the cost minimization determination was successively carried out at the preset times so that the specified sequence was performed at the preset times.
